(19) United States
(12) Patent Application Publication
(10) Pub. No.: US 2024/0410833 A1
(43) Pub. Date: Dec. 12, 2024

(54) METHODS, SYSTEMS, AND DEVICES FOR DETERMINING A PRESENCE OR CONCENTRATION OF A CHEMICAL IN A SAMPLE BASED ON IMAGE ANALYSIS

(71) Applicant: Research Triangle Institute, Research Triangle Park, NC (US)

(72) Inventor: Shannon Theresa Krauss, Holly Springs, NC (US)

(21) Appl. No.: 18/810,821

(22) Filed: Aug. 21, 2024

Related U.S. Application Data
(63) Continuation of application No. PCT/US23/63121, filed on Feb. 23, 2023.
(60) Provisional application No. 63/314,532, filed on Feb. 28, 2022.

(51) Int. Cl. G01N 21/78; G01N 1/38; G01N 21/01

(52) U.S. Cl. CPC G01N 21/78; G01N 1/38; G01N 2021/0125; G01N 2021/0137

(57) ABSTRACT

Disclosed herein are systems, methods, and devices for determining a presence or concentration of a chemical in a sample based on image analysis. In one embodiment, a computing system for image analysis includes one or more hardware computer processors configured to execute software instructions and one or more storage devices storing software instructions for execution by the one or more hardware computer processors configured to cause the computing system to perform the following steps. The computing system receives imaging data of at least one sample droplet of a sample and at least one reagent. One or more imaging properties are identified from the imaging data and a result is generated. The result indicates the presence or concentration of a chemical in the sample based on the identified imaging properties. The computing system stores the imaging data and the result.

### CROSS-REFERENCE TO RELATED APPLICATION

This application is a continuation of PCT patent application no. PCT/US2023/063121 titled “METHODS, SYSTEMS, AND DEVICES FOR DETERMINING A PRESENCE OR CONCENTRATION OF A CHEMICAL IN A SAMPLE BASED ON IMAGE ANALYSIS,” filed Feb. 23, 2023, which claims the benefit of priority of U.S. provisional patent application No. 63/314,532 titled “DIGITAL MICROFLUIDIC PLATFORM FOR AUTOMATED CHEMICAL DETECTION,” filed Feb. 28, 2022, which are all incorporated herein by their entireties by this reference.

### TECHNICAL FIELD

The present invention relates to image analysis and chemical detection, and more specifically, to determining a presence or concentration of a chemical in a sample based on image analysis.

### BACKGROUND

Chemical detection is an ongoing challenge for several federal agencies and industries. Compounds of interest range from illicit drugs and opioids, explosives, chemical or biological warfare agents, environmental pollutants, foodborne pathogens, or viruses and COVID-19. Many detection methods utilize color changes to indicate the presence of chemicals of interest (e.g., color tests and immunoassays). Color test protocols used in the laboratory are typically performed in a spot plate or test tube format whereby a color change is visually examined when an evidence sample is added to specific chemical reagents (different reagents change color in the presence of a different drug compound or drug class). Color tests are the predominant screening technique used in laboratory seized drug workflows. For example, the 4-aminophenol (4-AP) color test can be used to determine whether a Cannabis sample is hemp-rich or THC-rich. Color tests are advantageous due to the low cost, portability, and simplicity.

However, several disadvantages of color tests include: (1) large number and variability in the compounds of interest, (2) subjective nature of color interpretation, (3) only allows for one substance to be manually tested at a time, (4) no storage of data for traceability, recall, or review, (5) Lack of automation, and (6) cannot integrate into a laboratory information management system (LIMS).

In addition to color tests, lateral flow immunoassays (LFIs) can be used for detection of antibody or antigen in a chemical sample. In LFIs, fluid movement is driven along a cellulose strip based on capillary action, or wicking. In general, instead of using chemical reagents that change color in the presence of specific drugs of interest due to chemical structure, drug immunoassays and LFIs use capture antibodies of a complimentary chemical structure labeled with an indicator that changes color when substrate is added for detection. Similar to color tests, LFIs advantages are simplicity, low cost, rapid analysis times, and no external instrumentation.

LFIs, however, suffer from the same limitations as color tests. In addition to LFIs being routinely used in urine drug testing to provide an intuitive method for analysis due to the ubiquity of other LFIs, such as pregnancy tests, commercially available LFIs have also been used as field presumptive tests by law enforcement. For example, LFIs that incorporate and augment current color tests with drug immunoassays may improve the sensitivity, reliability, reproducibility, and accuracy of current workflows. Notably, including more than one drug test specific to a particular drug of interest can provide increased confidence in the results.

The prevalence of color tests for presumptive screening is due to the low cost, quick turnaround time, and simplicity in which color changes are observed visually. Limitations that arise with color test operation can include subjectivity, human factors, improper use, manual procedure, incorrect results recorded, uncontrolled interferents, and multiple individual color tests required for drug identification, all providing potential for user error or unreliable results. The susceptibility of color testing to these errors presents a need for improving the sensitivity, reliability, reproducibility, and accuracy of current workflows. Subsequent forensic laboratory analysis is performed for confirmation of presumptive testing, which includes replication of the color test. In addition to the challenges listed above, current technology lacks the ability to be automated and/or integrated with laboratory information management systems (LIMS).

Even though forensic laboratories have implemented more efficient processes and digitization, color testing has remained largely stagnant. Moreover, recent legislation has created an additional and unique color test challenge. The 2018 Farm Bill redefined hemp as Cannabis containing less than 0.3% Δ9-tetrahydrocannabinol (THC) and removed hemp from the controlled substances list. Prior to this legislation, forensic laboratory workflows focused solely on identification of THC rather than determining THC concentrations. The strain of this change halted Cannabis evidence processing in many laboratories until new protocols were developed, creating pressure to rapidly validate a presumptive color test, confirmatory method, new standard operating procedures, and any necessary training materials, all while juggling current caseloads demands.

The 4-aminophenol (4-AP) color test semi-quantitatively identifies cannabidiol (CBD)- or THC-rich Cannabis. The rapid adoption and implementation of this new 4-AP color test into forensic laboratory workflows for Cannabis highlights a preference to continue utilizing color tests in seized drug processing when possible. For example, currently, if a sample is seized for subsequent analysis within a forensic laboratory, an analytical workflow following recommendations from the Scientific Working Group for the Analysis of Seized Drugs is used to achieve a sufficient level of selectivity for a scientifically supported conclusion. This is generally a multistep process that includes screening and confirmation. The United Nations Office on Drugs and Crime's International Collaborative Exercises (ICE) reported color testing as the most common screening method.

Other methods, such as Raman spectroscopy and ion mobility spectrometry (IMS), also have limitations resolving drug mixtures which may result from, for example, weak intensity of Raman scattering with Raman spectroscopy and competitive ionization or unsolvable signals with IMS. Specifically, such current solutions cannot detect a minor illicit drug component in a drug sample that is majority excipient or cutting agent.

Drug use takes a costly toll on communities throughout the United States, and laboratory processing of seized drug evidence aids in enforcing public safety and controlling crime. As mentioned above, evolving drug landscapes and regulations can create analytical challenges for seized drug processing and detection within the criminal justice and forensic science communities.

These challenges present a need for improved methods and systems for more reliable, reproducible, accurate, and unbiased evidence processing results.

### SUMMARY OF DISCLOSURE

Disclosed herein are systems, methods, and devices for determining a presence or concentration of a chemical in a sample based on image analysis. In one embodiment, a computing system for image analysis includes one or more hardware computer processors configured to execute software instructions and one or more storage devices storing software instructions for execution by the one or more hardware computer processors configured to cause the computing system to perform the following steps. The computing system receives imaging data of at least one sample droplet of a sample and at least one reagent. One or more imaging properties are identified from the imaging data and a result is generated. The result indicates the presence or concentration of a chemical in the sample based on the identified imaging properties. The computing system stores the imaging data and the result.

In some embodiments, the reagent is associated with an immunoassay, a colorimetric reaction assay, or another chemical indicator. Colorimetric reactions can include color changes based on chemicals and chemical indicators. Chemical indicators can include, for example, pH tests, and may be different from chemicals that change the composition of a chemical of interest, a chemical reagent used, or precipitate out all allowing for a color change. Additionally, a colorimetric reaction assay may be different from an immunoassay or other bioassays which are based on antibodies or antigens.

In some embodiments, the computing system is configured to identify the imaging properties based on a subset of the imaging data.

In some embodiments, the computing system is configured to identify one or more image pixels to be analyzed and one or more image pixels to be excluded from being analyzed.

In some embodiments, the computing system is configured to generate a result based on the identified imaging properties by applying criteria associated with the reagent. It is appreciated that various criteria may be used to generate a result without departing from the scope of the subject matter disclosed herein. For example, the criteria can include a threshold value where applying the threshold may include generating a positive result if the concentration is above the threshold and a negative result if the concentration is below the threshold. Applying the criteria can also include quantification which, rather than using a threshold value, measures the response fit to a curve (e.g., linear) and extrapolates the concentration.

In some embodiments, the system also includes a sensor configured to capture the imaging data.

In some embodiments, the sensor includes one or more of: a microscope, a spectrophotometer, a camera, and a digital imaging device.

In some embodiments, the identified imaging properties include at least one of:

a size, a location, and a color.

In some embodiments, the imaging data is convertible into a viewable image.

In some embodiments, the imaging data is a Raster image file.

In some embodiments, the Raster image file is one of: a jpeg, a tiff, a gif, a png, a RAW, a Bitmap, an encapsulated postscript (ESP), and a portable document format (PDF).

In some embodiments, the system includes an additional device configured to at least one of: transport, aliquot, split, combine, or mix the at least one sample droplet and the at least one reagent.

In some embodiments, the additional device is one of: a test tube, a containment tube, a PCR tube, a multiple-well plate, a spot plate, a cuvette, a lateral flow assay, a test strip, pH paper, a substrate material, a reagent 3D printed into a polymeric material, a microfluidic system, and a digital microfluidic system.

In some embodiments, the digital microfluidic system includes a microfluidic device and a microprocessor coupled to the microfluidic device. The microfluidic device includes a substrate, one or more microfluidic channels arranged on or within the substrate, and one or more electrodes arranged on or within the substrate. A first portion of the microfluidic device is configured to receive a reagent and a second portion of the microfluidic device is configured to receive a sample droplet. The microprocessor coupled to the microfluidic device is configured to combine sample droplets and reagents by applying one or more electric potentials to the one or more electrodes.

In another embodiment, a method implemented on a computing device includes receiving imaging data of at least one sample droplet of a sample and at least one reagent. One or more imaging properties are identified from the imaging data and a result is generated indicating the presence or concentration of a chemical in the sample based on the identified imaging properties. The imaging data and the result are stored.

The subject matter described herein also includes a digital microfluidic system and associated method(s) for chemical detection. According to one embodiment, the digital microfluidic system includes a microfluidic device and a microprocessor coupled to the microfluidic device. The microfluidic device includes a substrate, one or more microfluidic channels arranged on or within the substrate, and one or more electrodes arranged on or within the substrate. At least one reagent is introduced to a first portion of the microfluidic device and at least one sample droplet is introduced to a second portion of the microfluidic device. The microprocessor is configured to combine the at least one sample droplet with the at least one reagent included on the microfluidic device. Combining the at least one sample droplet with the at least one reagent includes applying one or more electric potentials to the electrodes of the microfluidic device. A sensor, including any hardware or other device capable of capturing imaging data, is used to capture imaging data of the at least one sample droplet and the at least one reagent. One or more imaging properties are identified from the captured imaging data, including color data or other, and a result is generated. The result indicates the presence or concentration of a chemical in the sample based on the identified imaging properties. The captured imaging data and the result are stored.

According to another embodiment, a method for chemical detection using a digital microfluidic system includes combining at least one sample droplet with at least one reagent included on a digital microfluidic device of the digital microfluidic system. Combining a sample droplet with a reagent includes applying one or more digitally controlled electric potentials to electrodes of the digital microfluidic device. Utilizing a sensor, imaging data of the sample droplet(s) and the reagent(s) is captured. Imaging data can be captured before and/or after the sample droplet(s) and the reagent(s) are combined. One or more imaging properties are then identified from the captured imaging data and a result is generated. The result indicates the presence or concentration of a chemical in the sample based on the identified imaging properties. The captured imaging data and the result are stored.

### BRIEF DESCRIPTION OF THE DRAWINGS

FIG. 1 is a system diagram of a computing system for determining a presence or concentration of a chemical in a sample based on image analysis according to an embodiment of the subject matter described herein.

FIG. 2 is a flow chart of a computer-implemented method for determining a presence or concentration of a chemical in a sample based on image analysis according to an embodiment of the subject matter described herein.

FIG. 3 is a cross section view of a digital microfluidic system with a schematic according to an embodiment of the subject matter described herein.

FIG. 4 is a sequence of side views and corresponding top views of a sample droplet being divided into two sample droplets using a digital microfluidic system according to an embodiment of the subject matter described herein.

FIG. 5 is a schematic illustration of moving a sample droplet using a digital microfluidic system according to an embodiment of the subject matter described herein.

FIG. 6 is a schematic illustration of automated color testing of a sample using a digital microfluidic system according to an embodiment of the subject matter described herein.

FIG. 7 is a photo of a digital microfluidic system according to an embodiment of the subject matter described herein.

FIG. 8 is a close-up view of the digital microfluidic device in the digital microfluidic system shown in FIG. 7.

FIG. 9 is an illustration of a digital microfluidic device according to an embodiment of the subject matter described herein.

FIG. 10 is an illustration of a digital microfluidic device showing an exemplary positive cocaine color test according to an embodiment of the subject matter described herein.

FIG. 11 is an illustration of a digital microfluidic device showing an exemplary negative cocaine test according to an embodiment of the subject matter described herein.

FIG. 12 is an illustration of an image created from color and image data captured from an image sensor of a digital microfluidic device illustrating exemplary automated droplet detection according to an embodiment of the subject matter described herein.

FIG. 13 is an illustration of a digital microfluidic device illustrating splitting a liquid containing colored dye into one or more droplets according to an embodiment of the subject matter described herein.

FIG. 14 is an illustration of a digital microfluidic device illustrating combining multiple droplets, each containing a different dye, before the droplets are combined according to an embodiment of the subject matter described herein.

FIG. 15 is an illustration of a digital microfluidic device illustrating combining multiple droplets, each containing a different dye, after the droplets are combined according to an embodiment of the subject matter described herein.

FIG. 16 is an illustration of a digital microfluidic device having multiple liquids, each containing a different dye, each liquid having an associated droplet according to an embodiment of the subject matter described herein. The different dye can simulate one or more sample and one or more reagent.

FIG. 17 is a flow chart showing exemplary steps in a method for automated processing of a sample for chemical detection using a digital microfluidic system according to an embodiment of the subject matter described herein.

FIG. 18A is a raw image file that is first in a sequence of color test images illustrating a process of identifying one or more pixels to be analyzed from a captured color image of a sample after being combined with a reagent for detecting THC-rich or CBD-rich Cannabis sample according to an embodiment of the subject matter described herein.

FIG. 18B is a corrected image that is second in a sequence of color test images illustrating a process of identifying one or more pixels to be analyzed from a captured color image of a sample after being combined with a reagent for detecting THC-rich or CBD-rich Cannabis sample according to an embodiment of the subject matter described herein.

FIG. 18C is an image with certain pixel excluded that is third in a sequence of color test images illustrating a process of identifying one or more pixels to be analyzed from a captured color image of a sample after being combined with a reagent for detecting THC-rich or CBD-rich Cannabis sample according to an embodiment of the subject matter described herein.

FIG. 18D is an image with additional pixels excluded corresponding to plant material that is fourth in a sequence of color test images illustrating a process of identifying one or more pixels to be analyzed from a captured color image of a sample after being combined with a reagent for detecting THC-rich or CBD-rich Cannabis sample according to an embodiment of the subject matter described herein.

FIG. 18E is an image that selects the remaining color-changed pixels for analysis that is fifth in a sequence of color test images illustrating a process of identifying one or more pixels to be analyzed from a captured color image of a sample after being combined with a reagent for detecting THC-rich or CBD-rich Cannabis sample according to an embodiment of the subject matter described herein.

FIG. 19 depicts exemplary color responses for various concentration ratios of THC to CBD using the 4-AP test and representations of the corresponding color changes observed according to an embodiment of the subject matter described herein.

FIG. 20A is a perspective view of an exemplary image capture device for capturing color changes within spot plate wells using the 4-AP color test according to an embodiment of the subject matter described herein.

FIG. 20B is an image of a sample having a concentration ratio of THC to CBD greater than one according to an embodiment of the subject matter described herein.

FIG. 20C is an image of a sample having a concentration ratio of THC to CBD approximately equal to one according to an embodiment of the subject matter described herein.

FIG. 20D is an image of a sample having a concentration ratio of THC to CBD less than one according to an embodiment of the subject matter described herein.

FIG. 21A is first in a sequence of illustrations based on color images showing an exemplary image analysis workflow of a resultant 4-AP test color change for a sample solution according to an embodiment of the subject matter described herein.

FIG. 21B is second in a sequence of illustrations based on color images showing an exemplary image analysis workflow of a resultant 4-AP test color change for a sample solution according to an embodiment of the subject matter described herein.

FIG. 21C is third in a sequence of illustrations based on color images showing an exemplary image analysis workflow of a resultant 4-AP test color change for a sample solution according to an embodiment of the subject matter described herein.

FIG. 21D is fourth in a sequence of illustrations based on color images showing an exemplary image analysis workflow of a resultant 4-AP test color change for a sample solution according to an embodiment of the subject matter described herein.

FIG. 21E is first in a sequence of illustrations based on color images showing an exemplary image analysis workflow of a resultant 4-AP test color change for a solid sample (Cannabis Plant) according to an embodiment of the subject matter described herein.

FIG. 21F is second in a sequence of illustrations based on color images showing an exemplary image analysis workflow of a resultant 4-AP test color change for a solid sample (Cannabis Plant) according to an embodiment of the subject matter described herein.

FIG. 21G is third in a sequence of illustrations based on color images showing an exemplary image analysis workflow of a resultant 4-AP test color change for a solid sample (Cannabis Plant) according to an embodiment of the subject matter described herein.

FIG. 21H is fourth in a sequence of illustrations based on color images showing an exemplary image analysis workflow of a resultant 4-AP test color change for a solid sample (Cannabis Plant) according to an embodiment of the subject matter described herein.

FIG. 21I is fifth in a sequence of illustrations based on color images showing an exemplary image analysis workflow of a resultant 4-AP test color change for a solid sample (Cannabis Plant) according to an embodiment of the subject matter described herein.

FIG. 22 shows an exemplary image analysis of the color responses for a 1:1 ratio of THC and CBD at varying analyte concentrations and imaging timepoints according to an embodiment of the subject matter described herein.

FIG. 23A shows exemplary image analysis results for the color responses of various concentrations of THC at a 2-minute timepoint without image processing (raw images) and with image processing (image correction and pixel selection) according to an embodiment of the subject matter described herein.

FIG. 23B shows exemplary image analysis results for the color responses of various concentrations of CBD at a 2-minute timepoint without image processing (raw images) and with image processing (image correction and pixel selection) according to an embodiment of the subject matter described herein.

FIG. 24 shows exemplary color responses for samples with varied concentration ratios of THC to CBD using the 4-AP test where threshold values defining CBD-rich or THC-rich Cannabis are colored red and blue, respectively, according to an embodiment of the subject matter described herein.

FIG. 25 shows exemplary color responses for various cannabinoid solutions and resultant color changes for each cannabinoid according to an embodiment of the subject matter described herein.

FIG. 26 shows an exemplary user interface for importing imaging data according to an embodiment of the subject matter described herein.

FIG. 27 shows an exemplary user interface for selecting a white area in the image according to an embodiment of the subject matter described herein.

FIG. 28 shows an exemplary user interface for selecting one or more well(s) of interest for analysis according to an embodiment of the subject matter described herein.

FIG. 29 shows an exemplary Excel spreadsheet exported from the software program for reviewing the classifications according to an embodiment of the subject matter described herein.

### DETAILED DESCRIPTION

The subject matter described herein includes a computing device for determining a presence or concentration of a chemical in a sample based on image analysis. In one embodiment, the computing system includes one or more hardware computer processors configured to execute software instructions and one or more storage devices storing software instructions for execution by the one or more hardware computer processors configured to cause the computing system to perform the following steps. The computing system receives imaging data of at least one sample droplet of a sample and at least one reagent. One or more imaging properties are identified from the imaging data and a result is generated. The result indicates the presence or concentration of a chemical in the sample based on the identified imaging properties. The computing system stores the imaging data and the result.

In other embodiments, the computing system may include or be associated with one or more other devices configured to transport, aliquot, split, combine, or mix sample droplet(s) and reagent(s). Such devices can include: a test tube, a containment tube, a PCR tube, a multiple-well plate, a spot plate, pH paper, a substrate material, a reagent 3D printed into a polymeric material, or a digital microfluidic system. In an embodiment where the computing system includes or is associated with a digital microfluidic system, the digital microfluidic system can include a microfluidic device and a microprocessor coupled to the microfluidic device. The microfluidic device includes a substrate, one or more microfluidic channels arranged on or within the substrate, and one or more electrodes arranged on or within the substrate. A first portion of the microfluidic device is configured to receive the at least one reagent and a second portion of the microfluidic device is configured to receive the at least one sample droplet. The microprocessor is configured to combine the at least one sample droplet and the at least one reagent by applying one or more electric potentials to the one or more electrodes.

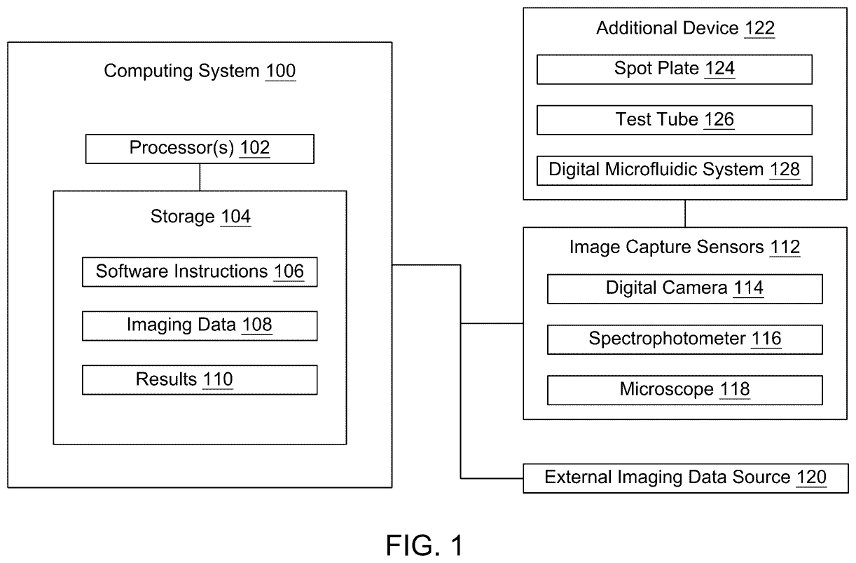

FIG. 1 is a system diagram of a computing system for determining a presence or concentration of a chemical in a sample based on image analysis according to an embodiment of the subject matter described herein.

Referring to FIG. 1, computing system 100 includes one or more hardware computer processors 102 configured to execute software instructions 106 and one or more storage devices 104 storing software instructions 106 for execution by the one or more hardware computer processors 102 configured to cause the computing system 100 to perform steps.

The computing system 100 receives imaging data 108, where the imaging data 108 is of at least one sample droplet of a sample and at least one reagent, from one or more image capture sensors 112, such as digital camera 114, spectrophotometer 116, or microscope 118. The one or more other devices 122 are configured to transport, aliquot, split, combine, or mix sample droplet(s) and reagent(s).

Alternatively, the computing system 100 may receive imaging data 108 from an external imaging data source 120, such as a database containing raw imaging data or viewable image files previously captured. The image capture sensor 112 may be associated with (e.g., co-located) an additional device 122, such as a spot plate 124, test tube 126, or digital microfluidic system 128, for capturing imaging data of sample(s) and reagent(s) in the additional device.

One or more imaging properties are identified from the imaging data 108 and a result 110 is generated. The result 110 indicates the presence or concentration of a chemical in the sample based on the identified imaging properties. The computing system 100 stores the imaging data 108 and the result 110.

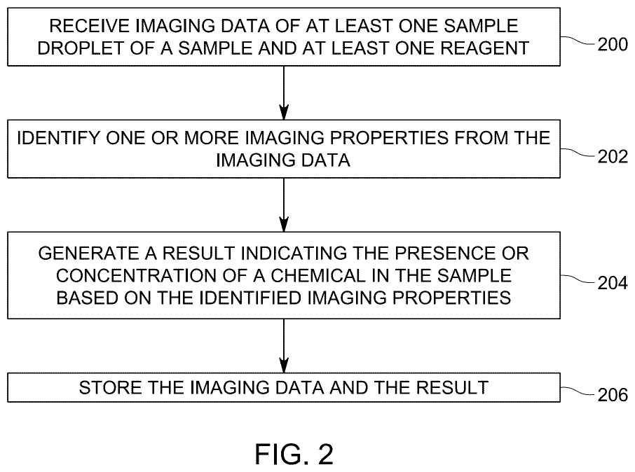

FIG. 2 is a flow chart of a computer-implemented method for determining a presence or concentration of a chemical in a sample based on image analysis according to an embodiment of the subject matter described herein.

At step 200, the computing system 100 receives imaging data of at least one sample droplet of a sample and at least one reagent.

For example, receiving the imaging data may include capturing the imaging data from a sensor such as a microscope, a spectrophotometer, a camera, and a digital imaging device. The imaging data may include a Raster image file, such as a jpeg, a tiff, a gif, or a png. Additionally, the imaging data converted into a viewable image. The imaging data may also be received from a source other than directly from a sensor, such as a database containing imaging data that was previously captured or otherwise generated.

The imaging data may be associated with a sample, one or more sample droplets, a reagent, and/or one or more reagents before and/or after being mixed. Typically, at least one sample droplet and at least one reagent are at least one of: transported, aliquoted, split, combined, or mixed prior to receiving the imaging data in one of a test tube, a spot plate, of a digital microfluidic system or any other suitable apparatus or material described herein. This allows for a change in the color of the sample when combined with the reagent(s) for indicating presence or concentration of a chemical in the sample. This color information is an example of imaging data.

For example, in an embodiment where sample droplets and reagents are combined using a digital microfluidic system, the digital microfluidic system may include a microfluidic device and microprocessor coupled to the microfluidic device. The microfluidic device may include a substrate, one or more microfluidic channels arranged on or within the substrate, one or more electrodes arranged on or within the substrate, a first portion of the microfluidic device configured to receive the at least one reagent, and a second portion of the microfluidic device configured to receive the at least one sample droplet. The microprocessor coupled to the microfluidic device may be configured to combine the at least one sample droplet and the at least one reagent by applying one or more electric potentials to the one or more electrodes.

At step 202, the computing system 100 identifies one or more imaging properties are identified from the imaging data. The identified imaging properties include at least one of: a size, a location, and a color. As used herein, “imaging data” and “image data” may be used interchangeably to refer to data produced by an optical or electronic sensor. “Imaging properties” may include both properties of an image file itself as well as properties of its production. In some cases, “image properties” may be used to refer to properties such as length, width, and file size of the image file, while “imaging properties” may be used to refer to properties such as the type of light, aperture, ISO, and camera model used to capture the imaging data. It is understood, however, that “imaging properties” includes both the properties of an image and the properties of its production unless otherwise specified.

The imaging properties identified from the imaging data may be based on either all of the imaging data or a subset of the imaging data. For example, identifying one or more imaging properties from the imaging data may include identifying one or more image pixels to be analyzed and one or more image pixels to be excluded from being analyzed.

In some embodiments, the imaging data may be converted into a viewable image, such as a Raster image file that can include a jpeg, a tiff, a gif, a png, or other image format.

At step 204, the computing system 100 generates a result. The result indicates the presence or concentration of a chemical in the sample based on the identified imaging properties. For example, the result may indicate the presence of THC in a sample.

At step 206, the computing system 100 stores the imaging data and the result. For example, color data for a sample captured both before and after being combined with a reagent may be stored along with the result indicating whether this color change indicated the presence or concentration of a chemical in the sample. This may allow for auditing of the result based on a review of the underlying imaging data.

The subject matter described herein may also include a digital microfluidic system 128 (also referred to herein as a digital microfluidic “platform”) and associated method(s) for chemical detection. According to one embodiment, the digital microfluidic system 128 includes a microfluidic device and a microprocessor coupled to the microfluidic device. The microfluidic device includes a substrate, one or more microfluidic channels arranged on or within the substrate, and one or more electrodes arranged on or within the substrate. At least one reagent is introduced to a first portion of the microfluidic device and at least one sample droplet is introduced to a second portion of the microfluidic device. The microprocessor is configured to combine the at least one sample droplet with the at least one reagent included on the microfluidic device. Combining the at least one sample droplet with the at least one reagent includes applying one or more electric potentials to the electrodes of the microfluidic device. A sensor is used to capture imaging data of the at least one sample droplet and the at least one reagent. One or more imaging properties are identified from the captured imaging data and a result is generated. The result indicates the presence or concentration of a chemical in the sample based on the identified imaging properties. The captured imaging data and the result are stored.

While at least one sample droplet and at least one reagent are combined to process a sample, the digital microfluidic system 128 may also perform at least one of the following additional or intermediate steps: transporting, aliquoting, splitting, combining, or mixing the at least one sample droplet and the at least one reagent. This allows for many combinations of sample droplets and reagents and, as a result, allows samples to be processed faster than conventional methods and systems with improved automation.

The captured color and image data may not be a viewable image. For example, unprocessed camera sensor data stored in RAW photo formats may include an m-by-n array of pixels (where m and n are the dimensions of the sensor) where each pixel contains light intensity values and color channel information (e.g., red, green, or blue). This unprocessed sensor data can be converted into a viewable image, such as a jpg, png, or tiff. All raster file and other file types are encompassed. Including .bmp, .jpeg, .gif, and .mp4. Videos or still-frame images may be identified. Identifying one or more imaging properties from the captured imaging data may include identifying one or more image pixels to be analyzed and identifying one or more image pixels to be excluded from being analyzed. For example, unwanted background features or lighting reflections may be excluded from the image analysis because they do not represent the color response of the sample droplet(s) after being mixed with the reagent(s). The result generated based on the identified imaging properties can include applying a criteria associated with each of the one or more reagents. For example, a threshold may be defined for classifying the identified image pixels to be analyzed as either a first color or a second color.

According to another embodiment, a method for chemical detection using a digital microfluidic system includes combining at least one sample droplet with at least one reagent included on a digital microfluidic device of the digital microfluidic system. Combining a sample droplet with a reagent includes applying one or more digitally-controlled electric potentials to electrodes of the digital microfluidic device. Utilizing a sensor, imaging data of the sample droplet(s) and the reagent(s) is captured. Imaging data can be captured before and/or after the sample droplet(s) and the reagent(s) are combined. One or more imaging properties are then identified from the captured imaging data and a result is generated. The result indicates the presence or concentration of a chemical in the sample based on the identified imaging properties. The captured imaging data and the result are stored.

In contrast to conventional methods and systems that require subjective color interpretation, only allow for one substance to be manually tested at a time, do not provide data storage for traceability, recall, or review, which lack automation, and cannot be integrated into a LIMS, the presently disclosed methods and systems allow for objective color interpretation, parallel substance testing, storage of data for traceability, recall, or review, automation, and can be integrated into a LIMS.

The disclosure herein includes a two-pronged approach for addressing the shortcomings of current color testing systems and methods. First, a digital microfluidic platform (also referred to herein as a digital microfluidic “system”) is used to perform color tests that includes automation, objective interpretation of results, performing multiple color tests in parallel, and collecting images of the results. Second, drug immunoassays are integrated into the platform to augment color tests for more reliable, reproducible, accurate, and unbiased results. This may be accomplished within a single system, or may alternatively be accomplished within a first system that conducts color tests and a second system that conducts immunoassays.

A digital microfluidic system may be approximately the size of a tissue box and use replaceable microfluidic devices that are approximately the size of a credit card. Additional specifications and parameters can be determined through design and experimentation. Microfluidic devices (also commonly known as microfluidic “chips”), droplet testing kits (various dye and buffer solutions), digital microprocessors, and software (computer-executable instructions for controlling droplets that can be optimized in house) as part of a compiled kit may be part of a given DMF platform or system. Incorporation of a camera or other imaging device with off-the-shelf DMF systems and parts are within the scope of the present disclosure.

Using a digital microfluidic (DMF) device or chip enables digital manipulation of droplets across electrodes, which could be in the form of an array, where different color tests can be performed at each droplet. A DMF system or platform, as disclosed herein, includes a DMF device that is integrated with a sensor for capturing imaging data, a processor for controlling the DMF device and performing analysis, and optionally a memory for storing the imaging data and the analysis results. The sensor, such as a digital camera is used for automated imaging and objective interpretation of color test results. Current color tests for seized drugs can be translated onto a DMF platform, sampling can be optimized for performing multiple color tests in parallel, and sampling and sample processing can be integrated for multiplexed analysis.

Additionally, objective image analysis methods for each color test are integrated into an algorithm for unbiased analysis and data integrity. Image analysis is a quantitative metric for measuring sensitivity, accuracy, and reproducibility and is considered an improvement on current color testing evaluations. In addition to the DMF platform being configured for image capture, objective image analysis methods may be optimized for each color test. The analysis method can then be used as a quantitative metric for evaluating and optimizing color test results.

Lastly, routine color tests can be augmented with drug immunoassays to incorporate more than one test per illicit drug for increased reliability of screening results. This may include translating immunoassays onto the DMF platform, optimizing and refining the image analysis method, and implementing a multiplexed method for performing immunoassays alongside the color tests.

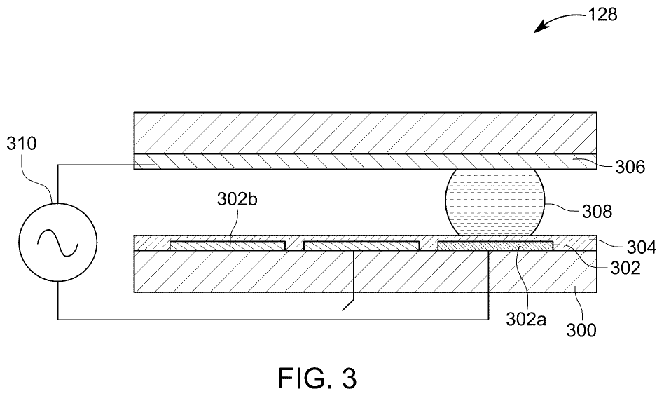

FIG. 3 is a cross-sectional view of a digital microfluidic device 128 with a sample droplet according to an embodiment of the subject matter described herein. The digital microfluidic (DMF) device 128 may include a substrate 300, a configuration of electrodes 302, dielectric layers 304 and 306, a hydrophobic layer, and an applied voltage 310. For example, the substrate 300 may be a glass plate in either one or two layers of glass. The bottom layer of the device may contain a patterned array of individually controllable electrodes 302, such as charged electrode 302a and uncharged electrode 302b. An applied voltage 310 may activate the electrodes to move, combine, and divide droplets. In order to move a droplet, a control voltage may be applied to an electrode adjacent to the droplet, and at the same time, the electrode under the droplet may be deactivated. By varying the electric potential along a linear array of electrodes, electrowetting can be used to move droplets along this line of electrodes.

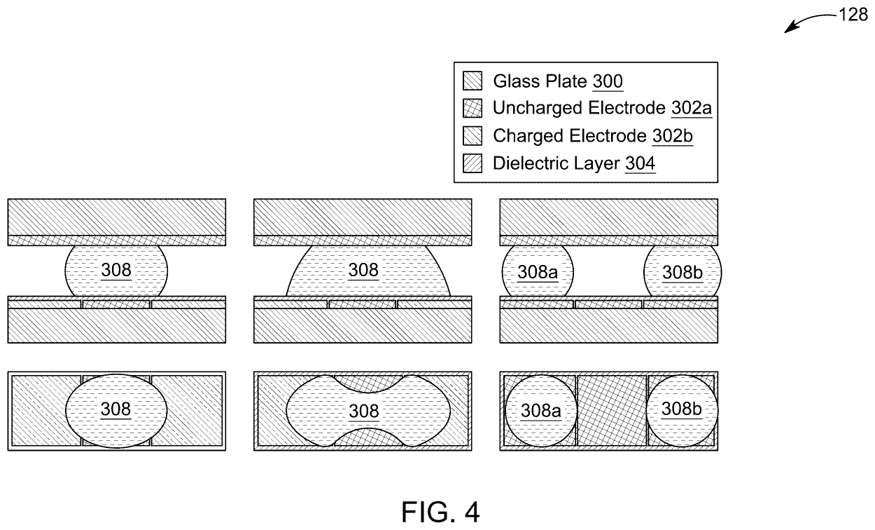

FIG. 4 is a sequence of side views and corresponding top views of a sample droplet 308 being divided into two sample droplets 308a and 308b using a digital microfluidic system 128 according to an embodiment of the subject matter described herein. A new droplet (e.g., 308a or 308b) can be formed with a digital microfluidic device 128 either by splitting an existing droplet 308 into two droplets (e.g., 308a or 308b) or a new droplet can be made from a reservoir of material. Once a droplet is located at a location on the plate corresponding to an electrode in the array of electrodes, the droplet may be divided, or aliquoted, into two smaller droplets.

A droplet can be split by charging two electrodes on opposite sides of a droplet on an uncharged electrode. In the same way a droplet on an uncharged electrode will move towards an adjacent, charged electrode, a droplet will move towards each neighboring active electrode. The droplet can thus be split by gradually changing the potential of the electrodes.

Droplets can also be merged into one droplet using the same concept applied to splitting an existing droplet with electrodes. An aqueous droplet resting on an uncharged electrode can move towards a charged electrode where droplets will join and merge into one droplet.

Discrete droplets can be transported in a highly controlled way using an array of electrodes. In the same way droplets move from an uncharged electrode to a charged electrode, or vice versa, droplets can be continuously transported along the electrodes by sequentially energizing the electrodes. Since droplet transportation involves an array of electrodes, multiple electrodes can be programmed to selectively apply a voltage to each electrode for better control over transporting multiple droplets.

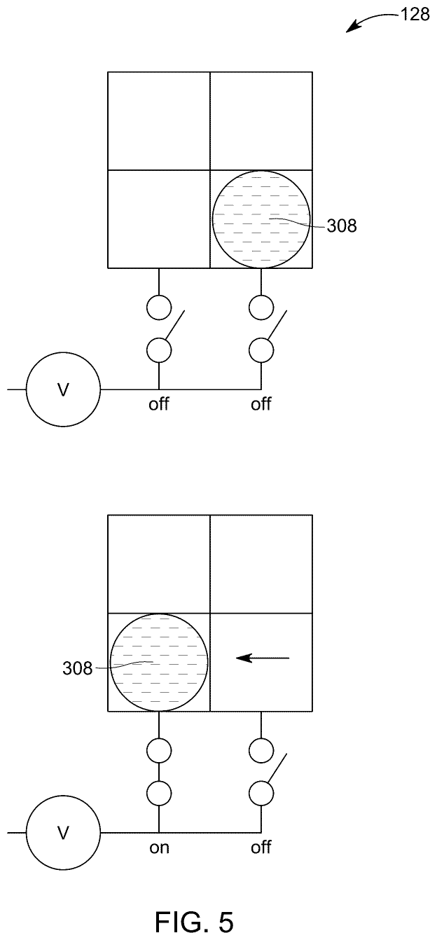

FIG. 5 is a schematic illustration of moving (translating) a sample droplet 308 from a first electrode to a second electrode using a digital microfluidic system 128 according to an embodiment of the subject matter described herein. As discussed above, a DMF device 128 allows for the manipulation of samples and reagents as discrete droplets 308 over an array of electrodes using electrostatic forces. Because fluids respond to an electric field, a series of digitally controlled electric potentials can be applied for droplet movement in a binary fashion by “turning on and off” electrodes.

For example, referring to FIG. 5, a droplet 308 is shown located in the bottom right portion of a DMF device corresponding to an electrode with no voltage applied. To the left of this electrode is another electrode, also with no voltage applied. In the bottom half of FIG. 5, the droplet 308 has been transported to the bottom left electrode after a voltage is applied to the bottom left electrode. In this way, samples and reagents can be manipulated as discrete droplets over an array of electrodes using electrostatic forces using a DMF system.

As mentioned above, DMF devices have several advantages over conventional color tests. First, each droplet serves as a color test “chamber” without requiring any tubes. Moreover, several droplets can be analyzed in parallel. Second, generic insulated electrode array format allows for flexibility and methods can be easily reconfigured and adapted using software. Third, several fluid manipulations, including transporting, aliquoting, combining, and mixing (analogous to pipetting steps) can all be preprogrammed for automation. Fourth, digital microfluidic devices are the size of a credit card with droplets less than a microliter in volume.

When compared with traditional color testing systems and methods, DMF offers faster turnaround time (e.g., 3× faster) because sample and reagent movements are completed within seconds and tests are performed simultaneously in parallel rather than sequentially. Additionally, when compared with other screening technologies, such as direct analysis in real-time mass spectrometry (DART-MS), DMF may be significantly less expensive (e.g., approximately 100×). DMF can also offer costs savings compared with other techniques (approximately 4-6× less expensive) such as dipsticks because other colorimetric based products (e.g., dipsticks) require multiple cartridges for sample identification and use a wicking format of cellulose membrane or paper-like material.

Digital microfluidic technology offers several advantages to address challenges with color testing. In addition to those listed above, microfluidics inherently offers scaled-down size, rapid analysis, minimal sample consumption, low cost, closed systems, and simple operating procedures. Because DMF allows for flexibility in the generic control of several individual droplets in parallel, DMF devices can perform multiple tests at once using the same sample input.

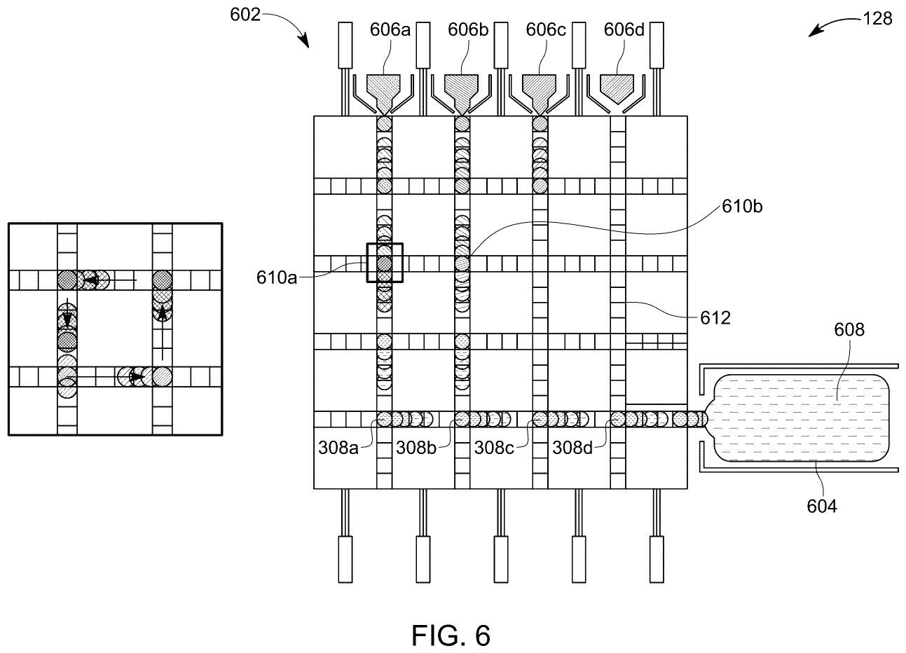

FIG. 6 is a schematic illustration of automated color testing of a sample using a digital microfluidic system 128 according to an embodiment of the subject matter described herein.

Individual color tests are integrated into the microfluidic operational method for multiplexed sample processing described herein. Digital control of sample and color test reagents using DMF control software is performed using a combination of microfluidic droplet manipulations, including sample splitting, reagent addition, combining, mixing, and transporting. Then, a sampling method is used for aliquoting, or sample splitting, within the DMF platform 128 so each sample droplet can be used to perform a different color test, all in parallel. Sample splitting in this format is used analogously to pipetting, whereby sample is taken from one tube multiple times to add to several different spot plate wells (or test tubes) to perform different color tests. After sample is added to the DMF platform, a DMF method will be optimized for moving sample to locations on the microfluidic device for mixing with the different color test reagents. Turbulent mixing is used to generate homogenous color changes that are ready for subsequent imaging and analysis.

Samples and reagents may be introduced to the DMF device in a variety of ways. For example, a microfluidic device may be configured for detection of a particular chemical by being pre-loaded or pre-stored within the device with one or more reagents. For example, reagents 606a, 606b, 606c, 606d may be introduced at a first portion 602 (e.g., top) of the microfluidic device 128. Alternatively, the DMF device 128 may not be pre-loaded with reagents to allow customization of the reagents used. Similarly, samples may be introduced to the DMF device in a variety of ways. In FIG. 6, a sample 608 is introduced to a second portion 604 (e.g., bottom right) of the microfluidic device and the sample is split into one or more sample droplets 308a, 308b, 308c, 308d. Alternatively, multiple different samples may be introduced to the DMF device allowing them to be processed in parallel.

As discussed above, droplets and reagents may be moved via one or more droplet cells 612 and combined to form mixed droplets 610a or 610b having desired combinations of reagents 606a, 606b, 606c, 606d and sample 608.

A schematic illustration of these processes on a DMF platform is illustrated in FIG. 6. FIG. 6 is a top-view schematic illustrating DMF sample processing functions, including sample splitting, reagent addition, combining, mixing, and transporting to perform multiple color tests simultaneously from a single sample input for rapid sized drug screening. In FIG. 6, a sample in carrier solvent is shown on the right side in dark blue and color test reagents are shown along the top in various colors. By precisely digitally activating and controlling the electrode array, the sample is split, or aliquoted, into discrete sample droplets and the reagents are individually transported as reagent droplets. The reagent droplets and the sample droplets are combined and mixed for producing multiplexed, simultaneous color reactions and replicates. This produces a homogenous color change in the mixed samples as a result, which may be imaged by an optical sensor for color analysis. Multiplexing can include different processes, e.g., one sample with multiple reagents or multiple samples and one reagent.

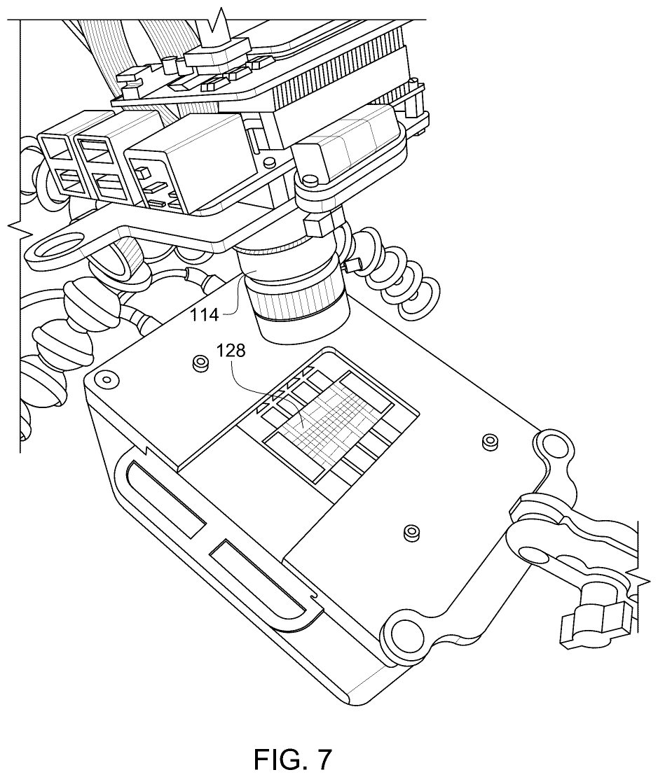

FIG. 7 is a photo of a digital microfluidic system 128 according to an embodiment of the subject matter described herein. The digital microfluidic system includes a digital microfluidic device 308 located within a stationary platform and a digital camera 114 positioned above the digital microfluidic device 308. The digital camera 114 captures imaging data of the digital microfluidic device. It is appreciated, however, that other sensors may also be used for capturing imaging data, such as fluorescence or spectrophotometric sensors. The digital microfluidic device may be coupled with a microprocessor and memory for controlling the voltages applied to electrodes of the digital microfluidic device, which allow for sample droplets and reagents in the digital microfluidic device to be moved, split, and combined.

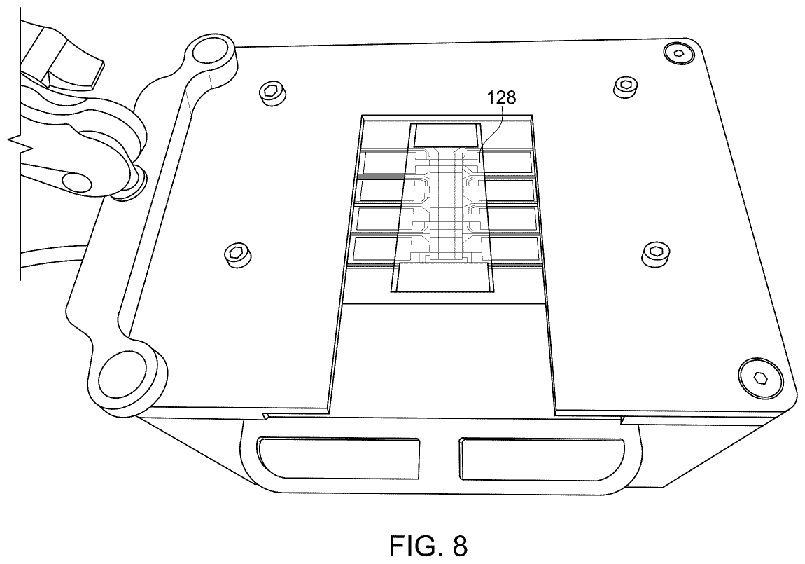

FIG. 8 is a close-up view of the digital microfluidic device in the digital microfluidic system 128 shown in FIG. 7. The digital microfluidic device may include a plurality of channels within a substrate for transporting, splitting, and mixing sample droplets and reagents. For example, the digital microfluidic device may include channels arranged in a grid or array of individual chambers where two channels intersect. Reagents may be introduced to the digital microfluidic device at a first portion of the digital microfluidic device, such as the left side of the device. Samples to be processed may be introduced to a second portion of the digital microfluidic device, such as the right side of the digital microfluidic device. The reagents and the sample droplets can then be moved, split, and combined in the various chambers in a third portion of the digital microfluidic device, such as the middle of the digital microfluidic device.

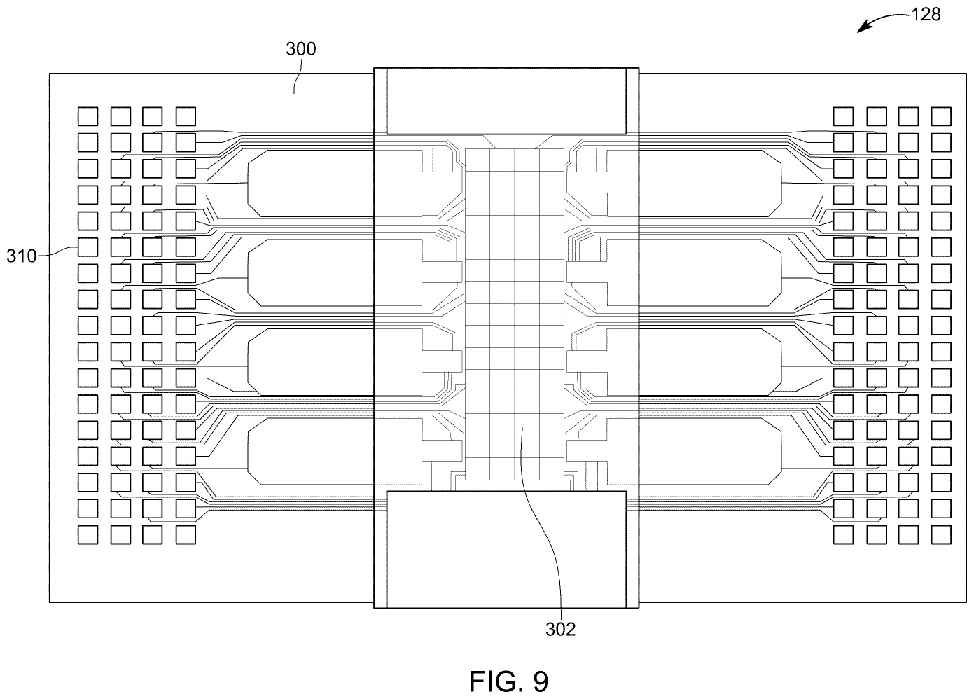

FIG. 9 is a photo of a digital microfluidic device according to an embodiment of the subject matter described herein. The microfluidic device includes a glass substrate, a plurality of microfluidic channels arranged within the substrate, and a plurality of electrodes arranged on or within the substrate. A microprocessor may be used to control the movement of droplets within the microfluidic device. For example, combining sample droplet(s) and reagent(s) includes applying one or more electric potentials to the electrodes of the microfluidic device. Like the configuration shown in FIG. 4, the example microfluidic device shown in FIG. 9 is a closed system. As opposed to an open system that includes one substrate layer of glass, a closed system two layers of glass with the droplets being contained between the layers. The bottom layer of the device may contain a patterned array of individually controllable electrodes. In a closed system, such as shown in FIG. 9, there may be a continuous ground electrode located in the top layer. Applying a voltage activates the electrodes and changes the wettability of droplet(s).

FIG. 10 is a representation of a digital microfluidic device showing a positive cocaine test and FIG. 11 is a photo of a digital microfluidic device showing a negative cocaine test, according to an embodiment of the subject matter described herein. As may be appreciated from FIGS. 10 and 11, when a sample droplet containing cocaine is mixed with the reagent the resulting mixture changes color. This color indicates the presence (or a concentration) of cocaine. When a sample droplet that does not cocaine, however, is mixed with the reagent, there either may be no color change in the mixture or the resulting color changes to a color that indicates the absence of cocaine.

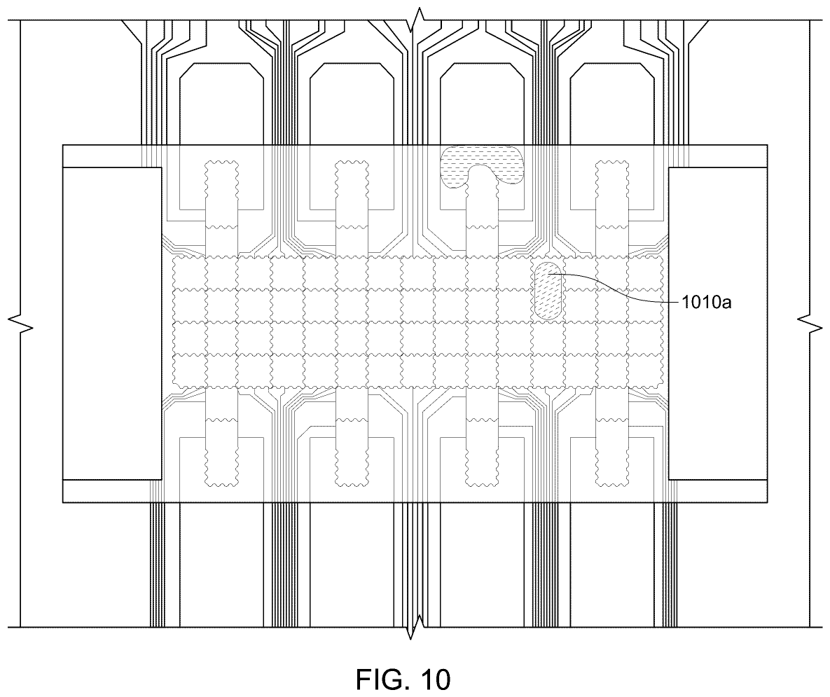

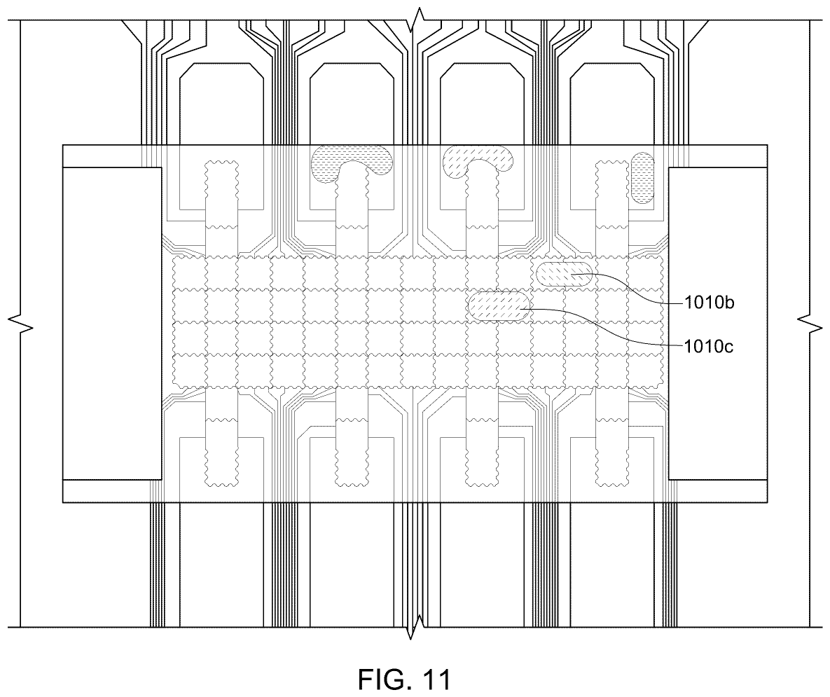

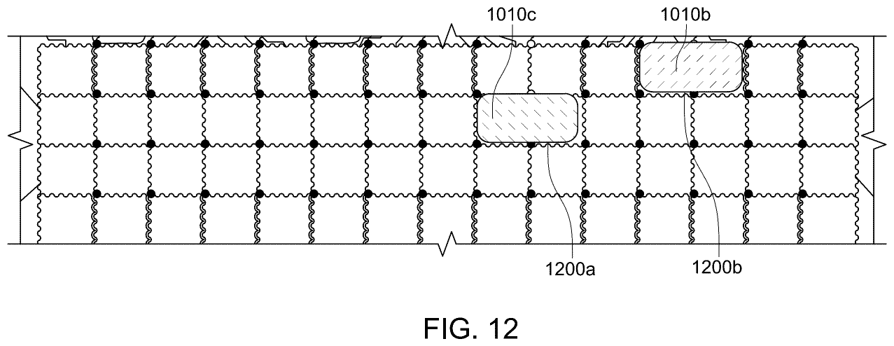

FIG. 12 is an image based on imaging data captured from an image sensor of a digital microfluidic device illustrating exemplary automated droplet detection using edge detection methodology and image processing according to an embodiment of the subject matter described herein. A first droplet (blue) and a second droplet (pink) may be located at different locations within the microfluidic device. For example, each droplet is shown occupying two adjacent cells and the droplets are separated from each other by at least one empty cell. Using automated image processing techniques, such as edge detection and color identification, the size, location, and/or color of the first droplet may be determined and identified as #151. Likewise, the size, location, and/or color of the second droplet may be determined and identified as #236. This information may be stored and used as the basis for further image analysis or auditing.

FIG. 13 is a photo of a digital microfluidic device illustrating splitting a liquid containing dye into one or more droplets according to an embodiment of the subject matter described herein. Here, the sample contains a green dye and is introduced to the upper right portion of the digital microfluidic device. The sample is aliquoted into seven sample droplets of approximately equal volume. As illustrated by the approximately equal color of each sample droplet, the concentration of dye in each droplet may also be approximately equal.

FIG. 14 is a photo of a digital microfluidic device illustrating combining multiple droplets, each containing a different dye, before the droplets are combined according to an embodiment of the subject matter described herein. Here, two samples are introduced to the digital microfluidic device as indicated by blue and yellow dye. Additionally, two reagents are introduced to the digital microfluidic device as indicated by red and green dye. A sample droplet from each of the samples and each of the reagents are located in the middle of the digital microfluidic device. The red reagent droplet and the blue sample droplet are located in neighboring cells, beginning a droplet combining protocol. The green reagent droplet and the yellow sample droplet are located in different neighboring cells.

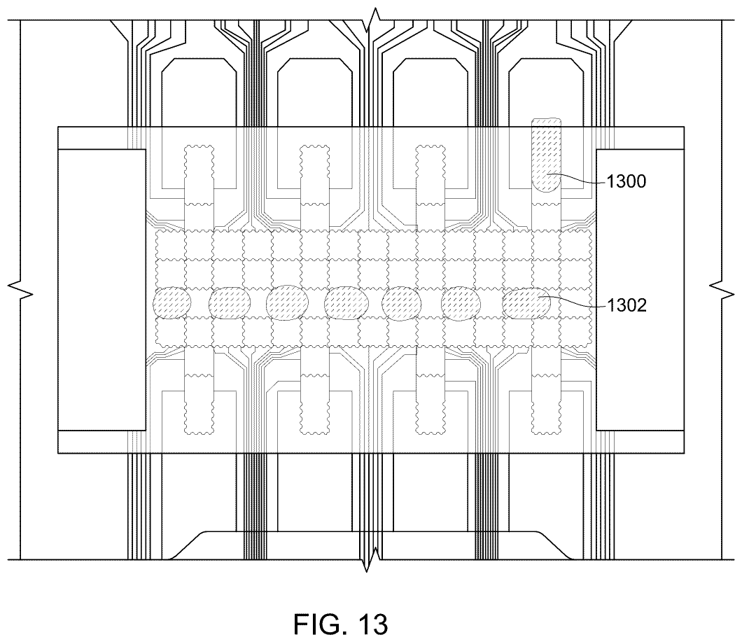

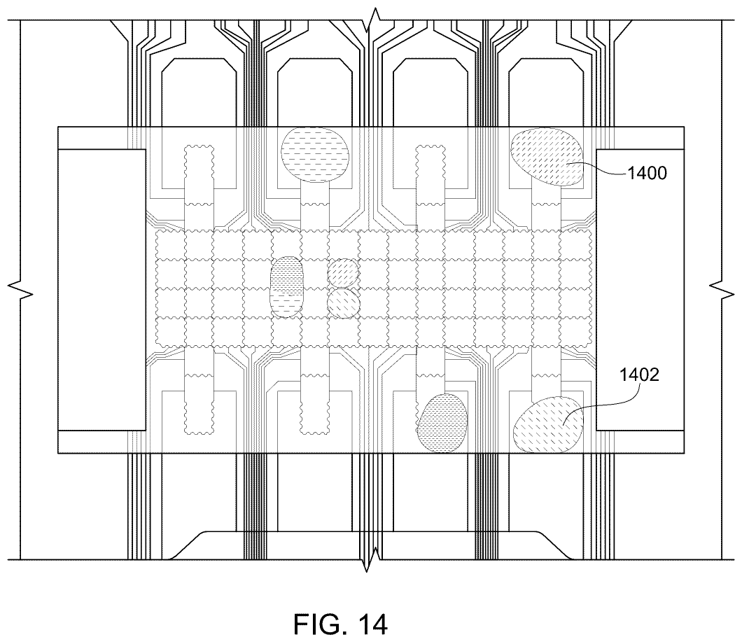

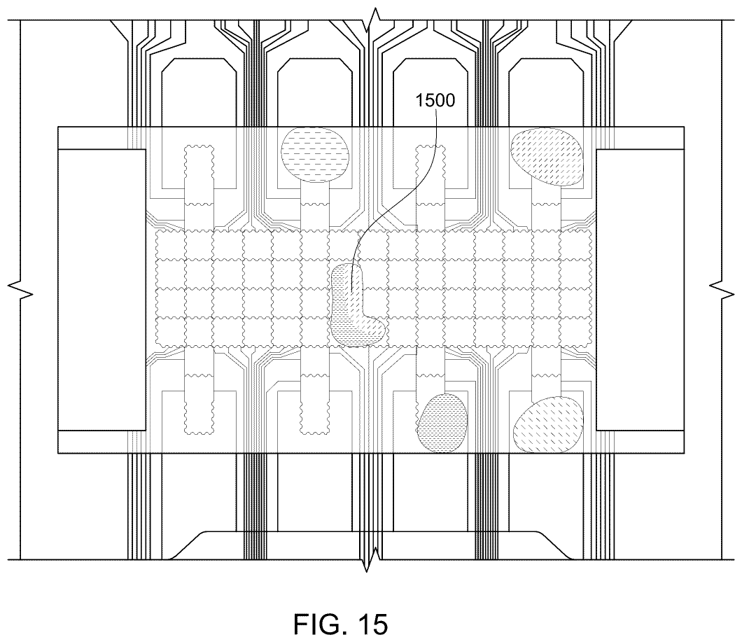

FIG. 15 is a photo of a digital microfluidic device illustrating combining multiple droplets, each containing a different dye, after the droplets are combined according to an embodiment of the subject matter described herein. A large droplet having a blue-green color and an L shape is shown resulting from combining at least one reagent and at least one sample droplet. For example, the pairs of reagent and sample droplets shown in FIG. 14 may be combined to form the L-shaped droplet shown in FIG. 15. The L shaped dropped is shown moving across multiple electrode positions.

FIG. 16 is a photo of a digital microfluidic device including four example liquids, each containing a different color dye, where a droplet has been split from each liquid, according to an embodiment of the subject matter described herein.

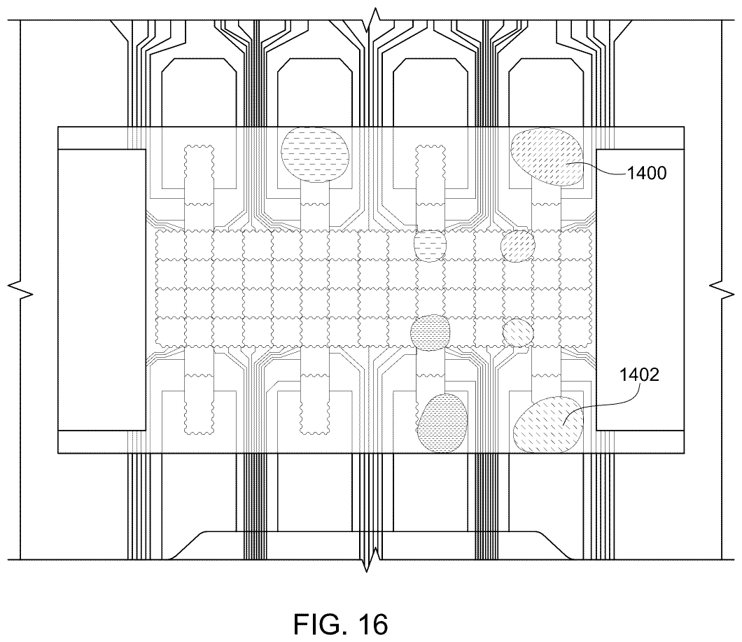

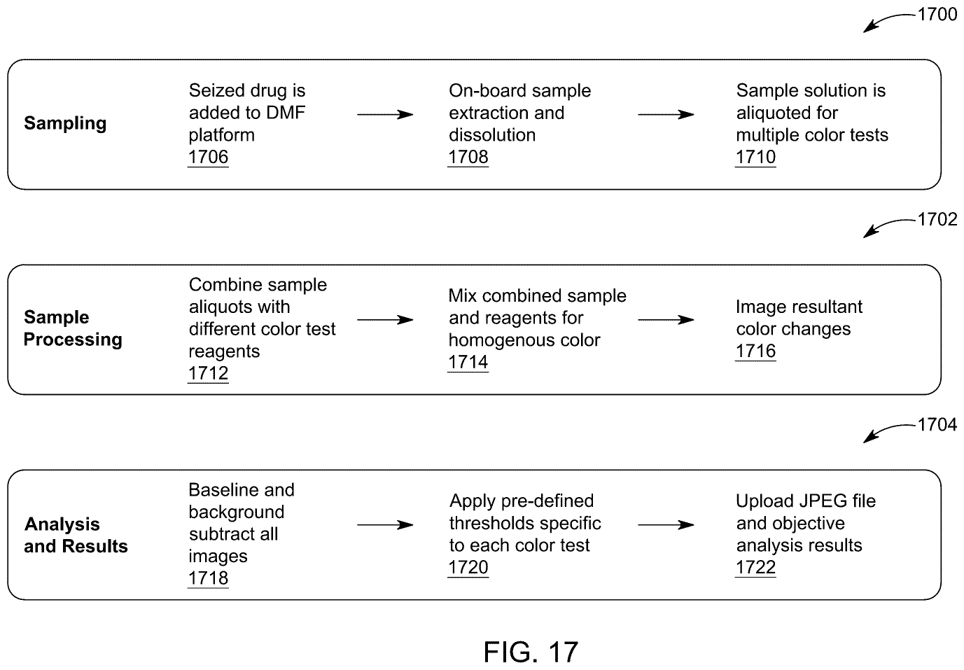

FIG. 17 is a flow chart showing exemplary steps in a method for automated processing of a sample for chemical detection using a digital microfluidic system 128 according to an embodiment of the subject matter described herein. The exemplary method may be divided into three components: sampling, sample processing, and analysis and results. FIG. 17 describes an overview of a DMF workflow, and each step can be broken into three parts: sampling, sample processing, and analysis and results. Within each DMF step, methods may be developed and optimized and, thereafter, these developments may be applied with color testing for drug immunoassays. Immunoassays result in a color change with drugs of interest, so methods can be easily adapted for increased bandwidth as more tests will be used for drug identification. Each of these components will now be described in greater detail.

Sampling begins when a seized drug or other substance to be tested for the presence or absence of a target chemical is added to the DMF platform. The sample is extracted and dissolved so that it may be easier to process (e.g., divide into droplets). Next, the sample solution is divided (aliquoted) into a plurality of droplets for multiple color tests.

Next, sample processing includes combining the sample aliquots with different color test reagents. The combined sample and reagents are mixed for producing homogeneous color. This may aid in image processing so that a combined sample has a consistent color without significant color variation. Finally, the resulting color changes of the combined samples are imaged. For example, a camera or other optical sensor may capture visual data (e.g., color images) of the combined sample droplets.

In one example, the analysis and results begins by establishing a baseline and subtracting a background from all images. For example, reflections on the surface of a droplet, portions of the DMF device surrounding that droplet, or extraneous material within the droplet may all be subtracted from the images in order to produce images that only contain the desired color data for each droplet. Next, one or more pre-defined thresholds, corresponding to each color test, are applied to the images. For example, a color value above a first pre-defined threshold may indicate a color that is clearly blue and not green, while a color value below a second pre-defined threshold may indicate a color that is clearly green and not blue. A color value that is between the first pre-defined threshold and the second pre-defined threshold may indicate the color that is neither clearly blue and nor clearly green (i.e., inconclusive). It may be appreciated, however, that the multi-step image analysis process mentioned above may not be required, depending on the application.

Lastly, the objective analysis and results, including any image files captured, may be automatically stored locally within the DMF platform and/or uploaded to a remote device. For example, results of the automated analysis may include a determination as to whether the sample has tested positive for a target chemical. This result may be displayed on the display of the DMF platform. Alternatively, or additionally, the DMF platform may include a wired or wireless communications device that allows the DMF platform to connect to a remote computer over a network, such as the internet. In a wireless example, the DMF platform may include either a cellular radio or a Wi-Fi radio for connecting to the internet. A remote data storage device, such as a database, may store results, imagery, and analysis data for multiple DMF platforms and multiple DMF tests. In a wired example, the DMF platform may be connected directly to another data storage device via USB.

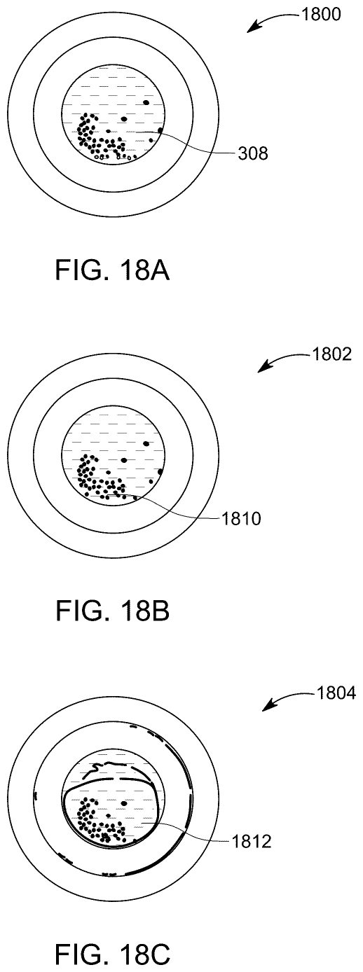

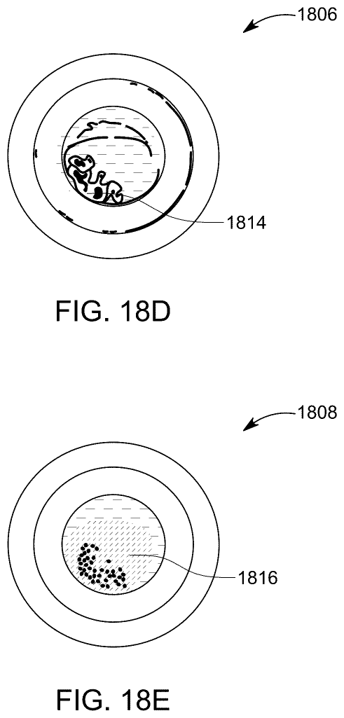

FIG. 18 is a sequence of images illustrating a process of identifying one or more pixels to be analyzed from a captured color image of a sample after being combined with a reagent according to an embodiment of the subject matter described herein. Drawbacks of the simplistic and subjective visual analysis approach routinely used with color tests can include variations in the interpretation of a perceived color, whether a consequence of the user or the color test chemistry. Objective interpretation of color test results can be achieved by implementing an image analysis approach based on color change or color intensity. For example, imaging can be seamlessly integrated into the DMF platform by affixing a camera to collect images of the resultant color changes. Incorporating automated image capture into the color test workflow can not only decrease the burden on forensic practitioners for color interpretation, but images can also allow for improved record keeping and tracking opportunities to recall, review, and store results. As workflows and evidence processing continue to move toward and embrace digitization, images are LIMS-compatible because most LIMS allow for incorporation of .jpeg files.

Collecting images of the resultant color changes aids in both developing an objective image analysis method for detection as well as guiding optimization and validation. Because color test interpretation is inherently subjective (visual), assigning a numerical value using color data (e.g., RGB) can provide an unbiased quantitative metric for evaluating results and performance metrics (e.g., detection limits, selectivity, error rates). The image analysis protocol disclosed herein may be refined by generating drug calibration curves using each corresponding color test to evaluate various color models for improved detection (e.g., HSB, CMYK, and LAB color models). Analysis can be individually optimized for each color test, then integrated into a single protocol allowing for an algorithm to perform automated analysis in parallel, indicating the results of each color test without practitioner interpretation required. Results can be exported into a simplified data file with key parameters.

Using objective imaging devices, including smartphones and cameras, image capture can be seamlessly implemented into a forensic laboratory workflow without disruption. Applying image capture to a forensic drug chemist workflow can decrease the burden on the color interpretation and can allow for improved record keeping opportunities. As mentioned above, these collected images can be used for an objective interpretation of color test by assigning a numerical value associated with the color change utilizing several color models (e.g., RGB color model). These numerical values can then be associated with a result from a color test and inform standard operating procedures (SOPs) and use-case improvements based on results from several different sample types, including challenge samples. These image analysis procedures can be applied to collected color test images shared from collaborating forensic laboratories.

In the present disclosure, additional image features may be used for improved analysis, automation, and detection. For example, image correction using background pixels (those not needed for detection) can account for lighting or other unintended differences between images. This can be accomplished using white balancing or other color correction techniques. Additionally, specific pixels of interest can be selected for analysis to exclude any unexpected or outlier pixels. This process can be accomplished using color thresholding or other pixel selection techniques to specify or exclude certain color ranges. Both of these described processes can be controlled in an automated and unbiased format for integration into the analysis protocol.

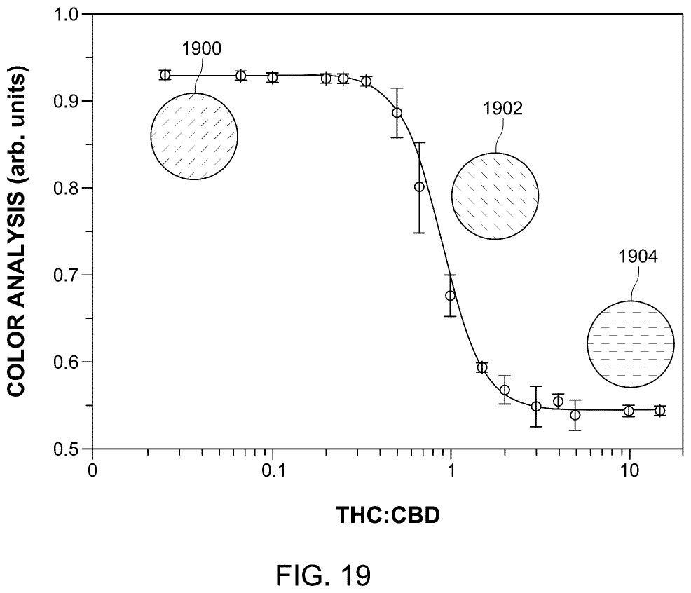

FIG. 19 depicts exemplary responses (e.g., color) for various concentrations ratios of THC to CBD using the 4-AP test and representations of the corresponding color changes observed according to an embodiment of the subject matter described herein. It may be appreciated that there can be a temporal analysis component with the imaging. That is to say that the color responses and observed color changes are not stagnant over time and may read different color values at different times (e.g., a first color or shade may be produced and observed at 30 seconds and a second color or shade may be produced and observed at 5 minutes).

FIG. 19 shows an exemplary standard curve from the 3 minute timepoint. Color data was extracted from the images using the HSB color model and plotted using the hue color channel reported in arbitrary units. All curve fits were sigmoidal and resulted in R2 values ranging from 0.9933 to 0.9996 for all four imaging timepoints (1-5 min). Sigmoidal curve fits were expected due to the presence of both blue and pink color at similar THC and CBD concentrations (near a 1:1 THC to CBD concentration ratio) that resulted in a mixed purple color. The exact chemical mechanism for the 4-AP test is not well-known.

As shown in FIG. 19, the basis of the 4-AP color test is that distinct colors result in the presence of CBD or THC based on differing chemical structures, and a sigmoidal calibration curve would be expected. Because different colors can result, the overall color change is based on a ratio of THC:CBD, which differs from currently used color tests where the overall color change is related to a single drug compound or chemical structure.

The sigmoidal curve in FIG. 19 demonstrates the change in color response over varying THC:CBD concentration ratios. From 15:1 to 4:1 THC:CBD, the color response was 0.56±0.01 image hue value (blue for THC-rich) and from 1:2 to 1:40 THC:CBD the color response was 0.92±0.01 hue value (pink for CBD-rich), with the linear range approximately 3:1 to 1:1 THC:CBD (purple for mixed), when the concentration of THC and CBD were similar and a mixture of blue and pink was observed. This calibration curve can be used to objectively interpret the color change from an unknown sample and classify it as either Cannabis that is THC- or CBD-rich. Additionally, the linear range of this sigmoidal curve can provide additional information about the sample since seized drug workflows currently call results within this range as “inconclusive.” Similarly, as with these proof-of-principle spot plate results, calibration curves will be generated using the DMF platform and the defined image analysis method will be used to investigate routine inconclusive color testing results.

Once the DMF platform has been adapted and utilized for color testing, the methods disclosed herein can be applied for use with routine drug immunoassays. Similar to color testing, immunoassays may test for drugs including Cannabis/THC, methamphetamine, cocaine, heroin, and fentanyl. Translating immunoassays onto the DMF platform may follow a similar process to translating color tests onto the DMF platform discussed above. However, unlike color tests where each separate reagent indicator binds or detects the drug compounds using differing mechanisms, the overall immunoassay mechanism is the same across all drugs and kits. It is appreciated that various immunoassay formats may be translated on the DMF platform without departing from the scope of the subject matter described herein where such immunoassay formats include, but are not limited to, sandwich, competitive, and antigen-down formats.

In one example, routine immunoassay kits are competitive assays that utilize the competition between enzyme-labeled drug and free drug from the sample for a fixed amount of drug-specific antibody binding sites. This creates an indirect relationship between drug concentration and enzyme activity. In terms of a color change in this example, as the concentration of drug in the sample increases, the color response decreases. Since the objective image analysis method is based on an overall change in color response, any change in color can be detected. Additionally, by having the same mechanism for all immunoassays (and only the drug-specific antibody and enzyme-labeled drug changes), translating each immunoassay onto the DMF platform is more streamlined.

In one embodiment, the DMF method for sample and reagent control only needs to be optimized for one assay and then the same can be applied for the remaining assays. Correspondingly, the image analysis method only needs to be optimized with one assay and then can be applied for use with all assays. Then, the image analysis method can be implemented to determine detection limits and related studies.

In another embodiment, the DMF method for sample and reagent control will need to be optimized for all immunoassays and the image analysis method will need to be optimized and applied for each assay. This is because each assay may have different detection limits, etc. to factor in.

As mentioned previously, drawbacks of the simplistic and subjective visual analysis approach routinely used with color tests, such as variations in the interpretation of a perceived color, may be overcome using a visual interpretation where inherent color information in an image resulting from a 4-AP color change can provide an objective analysis approach for interpreting and reporting the results. For example, image analysis compatible with current laboratory workflows was explored for the 4-AP test. THC and cannabidiol (CBD) may be successfully detected down to 0.05 mg mL⁻¹ using an image analysis approach. Additionally, threshold values may be defined for objectively interpreting and reporting results using drug standards and 35 different Cannabis plant samples of varying THC to CBD ratios. This new objective analysis approach will be discussed in greater detail below.

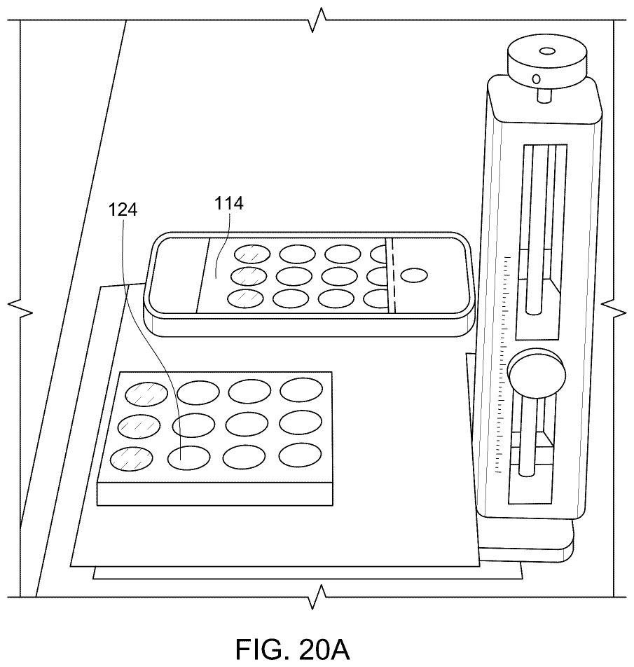

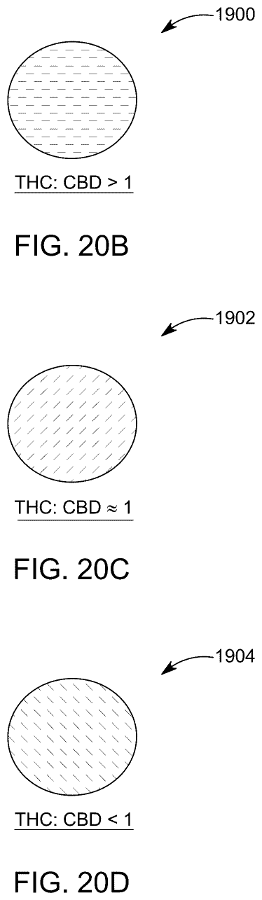

FIG. 20A is a perspective view of an exemplary image capture device for capturing color changes within spot plate wells using the 4-AP test according to an embodiment of the subject matter described herein. In the present disclosure, objective image analysis is used for the detection of THC or CBD-rich Cannabis with the 4-AP color test towards screening seized samples for marijuana or industrial hemp in forensic laboratory workflows. An image analysis method was applied to standard solutions of varying THC to CBD ratios and optimized for Cannabis plant material. Threshold values were defined using 35 Cannabis samples of known THC and CBD concentrations. The described objective image analysis format could reduce test or user specific variabilities, standardize the interpretation and reporting or results, and allow for improved storage of color test results.

The method may begin by selecting chemicals. Chemicals may include Δ-9-tetrahydrocannabinol and cannabidiol at 20 mg mL⁻¹ in ethanol, Δ-9-tetrahydrocannabinol, cannabidiol, Δ9-tetrahydrocannabinolic acid A, Δ-8-tetrahydrocannabinol, and cannabinol at 1 mg mL⁻¹ in methanol, 4-aminophenol, hydrochloric acid, ethanol, and sodium hydroxide. 4-AP regents may be stored in amber bottles in a 4° C. refrigerator. Reagent A may consist of 75 mg 4-AP, 248.75 mL ethanol, and 1.25 mL 2M hydrochloric acid, and reagent B was comprised of 12 g NaOH, 120 mL deionized water, and 280 mL ethanol.

Next, the method may include color test operation. When using standard drug solutions, the 4-AP color test may be performed by first adding 10 μL of standard drug solution to a polystyrene spot plate well, followed by 500 μL of Reagent A and 100 μL of Reagent B sequentially. When using Cannabis plant reference samples, a scoop tool may be used to add sample to the spot plate well, followed by the addition of 4-AP reagents using the identical standard drug solution procedure. The amount of Cannabis sample collected using the scoop tool may be measured as ≈2 mg.

Next, the method may include identifying reference cannabis samples. Homogenized Cannabis reference samples may be either hemp, marijuana, or a prepared mixture of hemp and marijuana to provide a range of THC to CBD concentration ratios. Each reference sample may be quantified using liquid chromatography with a photodiode array detector for CBD, CBDA, total CBD, THC, THCA, total THC compositions.

Finally, the method may include imaging and analysis. The imaging setup may use a smartphone positioned directly above the spot plate on a stand for consistent imaging. Before imaging a set of color tests, the smartphone camera may be put into AE-AF lock mode using spot plate wells filled with water to lock the focus and exposure settings. Images may be extracted from the smartphone for downstream processing. Resultant color changes within the spot plate wells of each image may be cropped to include only one well and saved as TIF files. The cropped images may be processed to correct image variabilities or subtract background image features, as needed, and specified color data was extracted using either ImageJ or MATLAB. Huc values may be reported as arbitrary units and used for data plots and defining threshold values.

Referring to FIGS. 20A-D, spot plates and test tubes may be used in forensic laboratories to perform colorimetric reactions for seized drug samples. In the embodiment shown in FIG. 18, the spot plate format was selected to allow for imaging above spot plate wells and closer to the colorimetric reaction solution. FIG. 18A shows an example imaging configuration for collecting images of resultant color changes from a 4-AP color test. A smartphone may be positioned on a stand directly above the spot plate and the configuration may be consistent for all standard solution and Cannabis plant material tests. It is appreciated that the imaging setup and imaging device configuration may also be adapted for imaging colorimetric reactions in test tubes and include cameras other than the cellphone camera shown.

FIG. 20B is a color image of a sample having a concentration ratio of THC to CBD greater than one according to an embodiment of the subject matter described herein. FIG. 20C is a color image of a sample having a concentration ratio of THC to CBD approximately equal to one according to an embodiment of the subject matter described herein. FIG. 20D is a color image of a sample having a concentration ratio of THC to CBD less than one according to an embodiment of the subject matter described herein. Thus, FIGS. 20B-D are exemplary images using the 4-AP color test of the expected blue, purple, and pink resultant color changes for a THC:CBD ratio greater than 1, THC:CBD ratio approximately equal to 1, and a THC:CBD ratio less than 1, respectively. FIGS. 20B-D images may be associated with a standard solution with a constant THC concentration of 1 mg mL⁻¹ (0.1% w/v THC) and a varied CBD concentration to result in the desired ratios of 15:1, 1:1, and 1:15 THC to CBD. A blank test containing no THC or CBD may result in a yellow color (not shown).

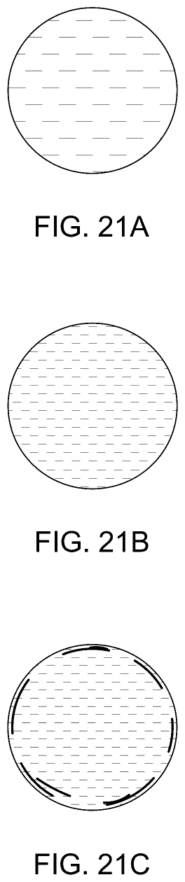

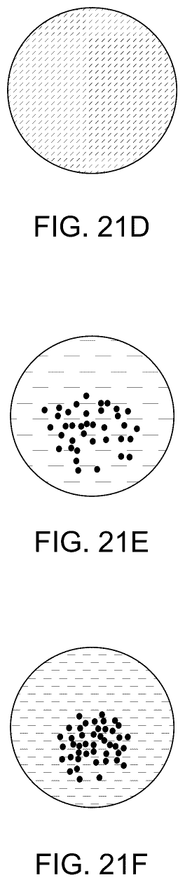

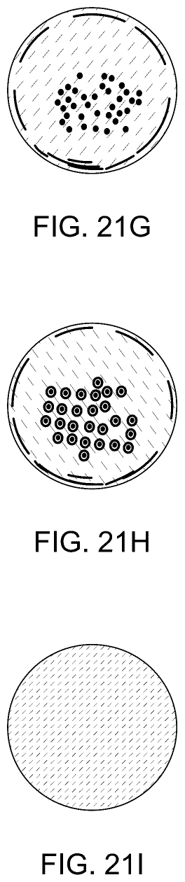

FIG. 21 are images showing an exemplary image analysis workflow of a resultant 4-AP test color change for two different samples: a sample solution illustrated as sequence (a)-(d) and a solid sample (Cannabis Plant) illustrated as sequence (c)-(i), according to an embodiment of the subject matter described herein. Prior to extracting color values from the images for analysis and interpreting results, image processing can be used to correct image variabilities, e.g., lighting and tone, or to exclude or subtract image features, e.g., reflection from indoor overhead lights. Additionally, specific background features or colors can be excluded from the extracted data used for analysis. FIG. 21 shows a representative image processing workflow for a 4-AP test with THC standard solution. The amount of desired image correction can vary with the imaging setup with the goal of consistency across all sample images for analysis. This image processing workflow can also be adapted for use with Cannabis plant materials (FIG. 21(e-i)) with the inclusion of an additional step that excludes large plant material fragments from the selected area for analysis. Additionally, since the resultant color for a blank sample with no THC or CBD present results in a yellow color and is not one of the expected positive resultant colors, image processing can also be used to exclude blank results indicative of no plant material present.

Defining and validating threshold values for analysis is the predominant technique used for objectively interpreting and reporting results in a drug “present” or “not present” (yes/no) format. Predefined thresholds associated with the resultant color changes for the 4-AP test can be used to determine if a Cannabis sample is either THC- or CBD-rich. Since the resultant color changes from the 4-AP color test can vary, alternatively to color tests that result in a monotone or singular color change, a standard curve was generated over a wide range of concentration ratios of THC to CBD to determine a method for image analysis and defining thresholds. Standard solutions were prepared at consistent THC concentration (1.0 mg mL-1 or 0.1% w/v THC) and varied CBD concentrations to generate THC to CBD concentration ratios of 15:1, 10:1, 5:1, 4:1, 3:1, 2:1, 1.5:1, 1:1, 1:1.5, 1:2, 1:3, 1:4, 1:5, 1:10, 1:15, and 1:40. The 4-AP color test was performed by first adding the THC to CBD concentration ratio mixture to a spot plate well, followed by the addition of Reagent A and then Reagent B. Images were taken of the resultant color changes at 1 min, 2 min, 3 min, and 5 min timepoints to measure any temporal differences in the color changes.

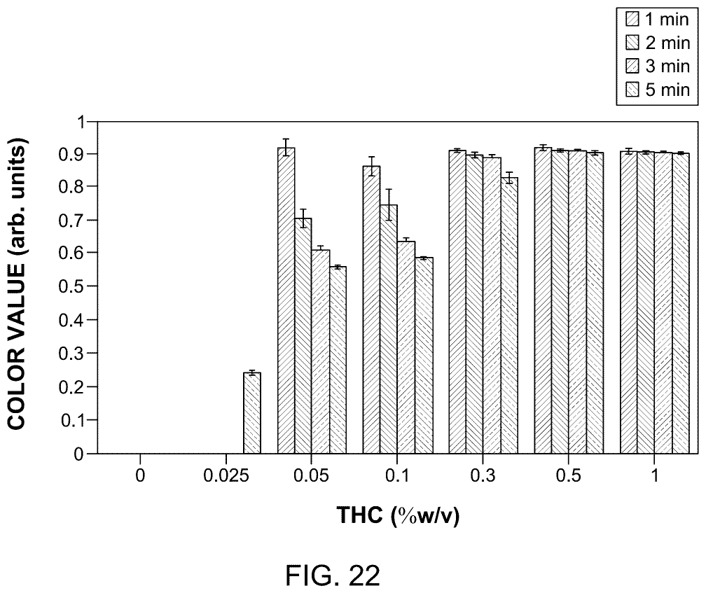

FIG. 22 shows an exemplary image analysis of the color responses for a 1:1 ratio of THC and CBD at varying analyte concentrations and imaging timepoints according to an embodiment of the subject matter described herein. FIG. 22 shows an image analysis of the color responses for a 1:1 ratio of THC and CBD at varying analyte concentrations and imaging timepoints. Average and standard deviations are represented for 3 replicates.

Referring to FIG. 22, as the concentrations increased (at a 1:1 ratio), the resultant 4-AP test color changes were more pink-colored (≈0.9 arb. units). A more pink-colored solution is indicative of a CBD-rich sample. At 0.5% w/v and 1.0% w/v THC and CBD, there was no difference in the color response between 1 and 5 min timepoints. Alternatively, as the concentration of THC and CBD decreased (at a constant 1:1 ratio), there was a greater change in the color responses from 1 to 5 min. For 0.025% w/v and 0.05% w/v THC and CBD, the resultant color response at 1 min was indicative of a pink-colored solution (or a CBD-rich sample), the resultant color responses at 2 and 3 min were indicative of a purple-colored solution (or ≈1:1 ratio), and the resultant color response at 5 min was indicative of a blue-colored solution (or a THC-rich sample). These differences in the color changes observed at a constant 1:1 THC to CBD with varied overall THC and CBD concentrations demonstrated the impact of concentration beyond just the relative THC to CBD ratio on the resultant color changes. Additionally, the timing of the image capture impacted results at lower THC and CBD concentrations. Due to the image processing, a blank solution with no THC or CBD present results in no extracted hue value output and is excluded. Similarly, hue values were not extracted for 0.025% w/v THC and CBD at 1-3 min timepoints (resultant color changes undetectable from the blank). However, the detected color change with 0.025% w/v at 5 min was not indicative of an expected color change for either a THC or CBD rich sample at ≈0.25 arb. units.

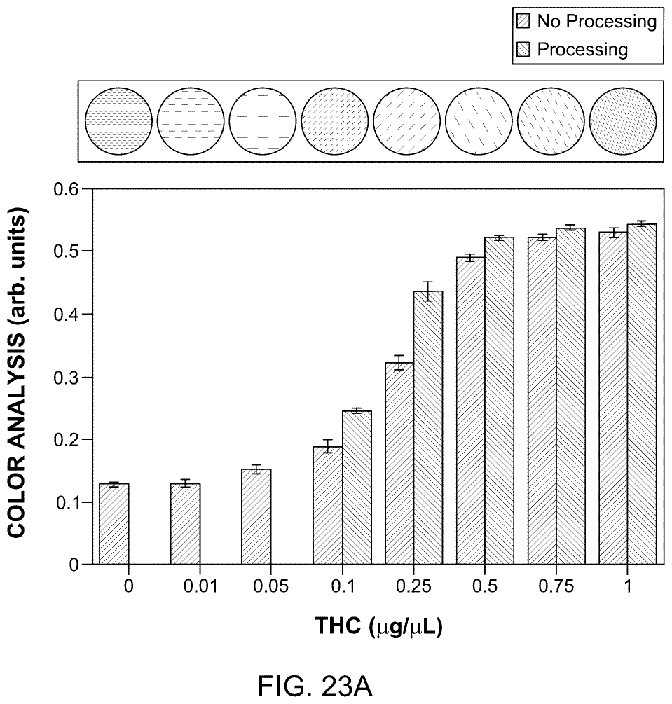

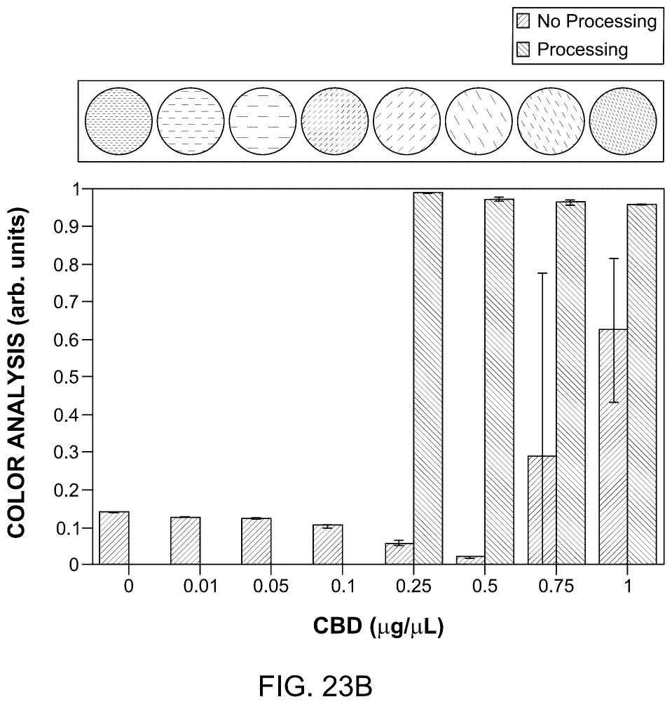

FIG. 23 shows exemplary image analysis results for the color responses of various concentrations of (a) THC and (b) CBD at a 2 minute timepoint without image processing (raw images) and with image processing (image correction and pixel selection) according to an embodiment of the subject matter described herein. FIG. 23 shows image analysis results for the color responses of various concentrations of (a) THC and (b) CBD with the 4-AP test for unprocessed and processed photos for the 2 min imaging timepoint. No data outputs resulted for THC and CBD concentrations below 0.1 μg/μL and 0.25 μg/μL, respectively, with image processing. Average and standard deviations represented for 3 replicates, and image insets above data plots demonstrate exemplary resultant color changes at each concentration.

The limit of detection (LOD) for THC with the 4-AP test using image analysis was empirically determined to be 0.05 mg mL⁻¹ for both analysis formats without image processing (or using the raw smartphone images) and with image processing (image correction and pixel selection). The LOD was defined by a hue value greater than 3-times the standard deviation (+36) of the hue value for 0 mg mL⁻¹ THC at each timepoint. FIG. 23(a) shows the image analysis results over a range of THC concentrations for the 2 min timepoint. Color data below the LOD was not detected using image processing since these resultant colors were more similar to a blank resultant color and were excluded from analysis. Similarly, the LOD for CBD was empirically determined to be 0.5 mg mL⁻¹ without image processing and 0.25 mg mL⁻¹ with image processing. LODs were defined by a hue value greater than 3-times the standard deviation (+36) of the hue value for 0 mg mL⁻¹ CBD, and FIG. 23(b) shows image analysis results for various CBD concentrations at the 2 min timepoint.

Table 1 below shows empirically determined LODs for THC and CBD at each imaging timepoint (1 min, 2 min, 3 min, and 5 min) with and without image processing.

| | |
|---|---|
| No Processing | Processing |

| Timepoint | THC | CBD | THC | CBD |
|---|---|---|---|---|
| (min) | (μg/μL) | (μg/μL) | (μg/μL) | (μg/μL) |
| 1.0 | 0.05 | 0.10 | 0.25 | 0.25 |
| 2.0 | 0.05 | 0.01 | 0.10 | 0.25 |
| 3.0 | 0.05 | 0.05 | 0.05 | 0.25 |
| 5.0 | 0.05 | 0.05 | 0.05 | 0.25 |

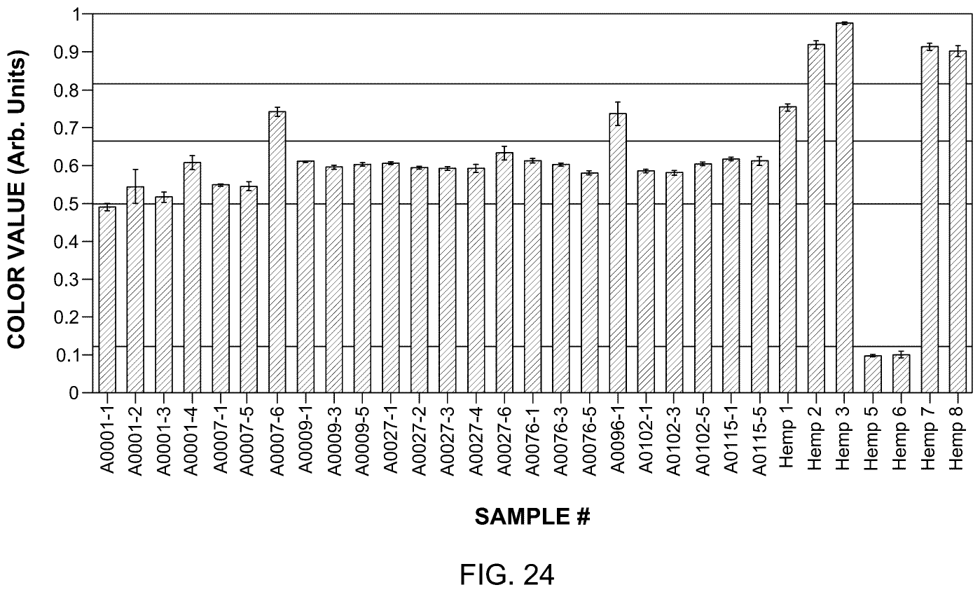

FIG. 24 shows exemplary color responses for samples with varied concentration ratios of THC to CBD using the 4-AP test where threshold values defining CBD-rich or THC-rich Cannabis are colored red and blue, respectively, according to an embodiment of the subject matter described herein. FIG. 24 shows Image analysis of the color responses at a 2 min timepoint for ground Cannabis samples with varied concentration ratios of THC to CBD using the 4-AP test. Overlaid threshold values used to define CBD-rich or THC-rich Cannabis are colored red and blue, respectively. Average and standard deviations represented for 3 replicates.

Predefined threshold values can be used for simple analysis of an unknown sample. Based on the standard curve data for the 3 min timepoint shown in FIG. 21, threshold values for the THC and CBD standard solutions resulted in 0.918-0.935 arb. units for a CBD-rich sample and 0.528-0.562 arb. units for a THC-rich sample. Threshold values for a CBD-rich sample were defined by the color analysis hue value greater than 3-times the standard deviation and the value less than 3-times the standard deviation of the average hue values from THC to CBD concentration ratios 1:3-1:40. Similarly, threshold values for a CBD-rich sample were defined by the color analysis hue value greater than and less than 3-times the standard deviation of the average hue values from THC to CBD concentration ratios 3:1-15:1. Unknown samples that fall within these predefined threshold values can be considered CBD- or THC-rich, respectively. A color value between 0.563-0.917 arb. units, or the linear range of the sigmoidal standard curve, was indicative of a sample with a similar THC to CBD concentration ratio (between 2:1 and 1:2 THC:CBD). Any value that falls outside of these three predefined threshold ranges would be considered inconclusive. Applying image analysis on Cannabis samples with the 4-AP test required optimization of these threshold values generated using standard solutions of THC and CBD.

Several ground Cannabis samples with known THC and CBD concentrations were used. To simplify test operation towards increased case-of-use in a forensic laboratory, a ≈2 mg scoop measuring tool was used for adding Cannabis plant samples to the spot plates. After the Cannabis samples were added, the 4-AP color test was performed following the standard solution protocol (500 μL of Reagent A and then 100 μL of Reagent B). Image analysis results for the Cannabis samples are shown in FIG. 23.

Threshold values for a THC-rich Cannabis sample were defined by the hue value greater than and less than 3-times the standard deviation of the average hue values. Unknown Cannabis samples that result in hue values that fall within 0.505 arb. units—0.672 arb. units can be considered THC-rich. Although some samples resulted in a hue value within the THC-rich threshold value range and were comprised of a total THC greater than 0.3%, these samples were not included in the threshold calculation because of the high total % CBD content.

Due to the process that linearizes hue data, values near 0 and 1 arb. units are red colored requiring the need for two threshold value ranges. Therefore, the first range of threshold values for a CBD-rich Cannabis sample were defined by the hue value greater than and less than 3-times the standard deviation of the average hue values from a first set of samples, and the second range of threshold values from a second set of samples. Unknown Cannabis samples that result in hue values that fall within 0.093 arb. units—0.106 arb. units or 0.828 arb. units—1.026 arb. can be considered CBD-rich.

Values that fall between 0.675 arb. units—0.828 arb. units can be considered Cannabis samples with similar THC and CBD concentrations and would likely result in a purple-colored sample. Yet another sample, which fell within this range was a marijuana sample with increased CBD content, may have resulted in a value within this mixed colored range. Lastly, a marijuana sample that fell below the THC-rich threshold value (0.489±0.009 arb. units) may be because the resultant, colored product was green, alternatively to the expected blue color for the 4-AP test.

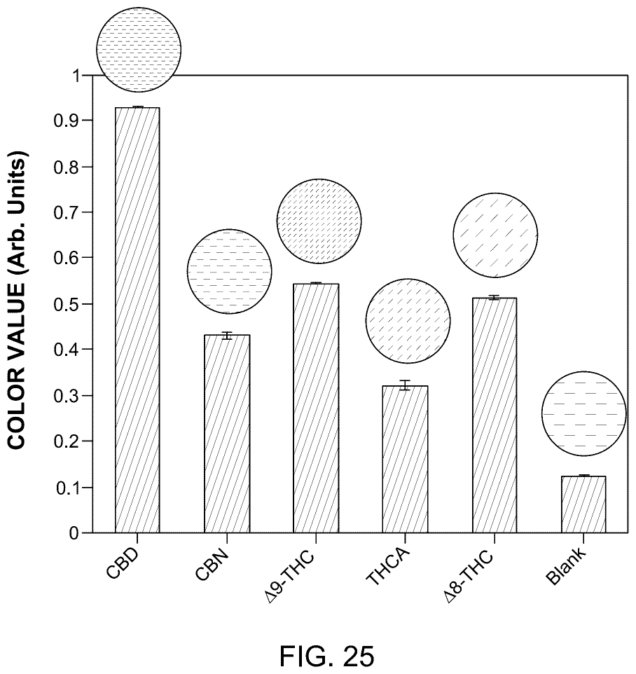

FIG. 25 shows exemplary color responses for various cannabinoid solutions and resultant color changes for each cannabinoid according to an embodiment of the subject matter described herein. FIG. 25 shows image analysis of the color responses at a 2 min timepoint for drug standard solutions of at 0.1% w/v Δ9-THC, CBD, THCA, Δ8-THC, and CBN. Average and standard deviations represented for 3 replicates, where the color image insets above the data plots illustrate exemplary resultant color changes for each cannabinoid.

Thus, FIG. 25 shows image analysis and resultant color changes for other cannabinoids compared to CBD and THC to determine other compounds that could result in a similar, green-colored product. Standard drug solutions of THC (or Δ9-THC), CBD, Δ9-tetrahydrocannabinolic acid A (THCA), Δ-8-tetrahydrocannabinol (Δ8-THC), and cannabinol (CBN) at 0.1% w/v concentrations were evaluated at the 2 min timepoint. CBN resulted in a green color with the 4-AP test (FIG. 17). Therefore, an unknown Cannabis sample would be considered inconclusive since a green-colored product could also be the result of a sample with CBN and no THC present although the sample was known to contain THC.

As discussed above, the 4-AP color test can determine THC- and CBD-rich drug samples to address recent legislation redefining hemp and removing it from the controlled substances list. Although color tests can offer a method for simple qualitative analysis, drawbacks can include variations in the interpretation of a perceived color. Images are uniquely compatible for use with color tests because of the inherent color information captured within a photo.

An objective image analysis method using a smartphone camera to capture photos can be applied for the detection of THC and CBD-rich samples using the 4-AP test for interpreting and reporting results with quantitative values. Image post-processing may also be performed prior to extracting color information for analysis and interpreting results. Image processing may be used to correct image variabilities and exclude background, environmental features, large Cannabis plant fragments, or blank samples from the image analysis and results. Using objective image analysis, both CBD and THC may be detected down to 0.05 mg mL⁻¹. Additionally, image analysis of 4-AP resultant color changes over varying ratios of THC and CBD (15:1-1:40 THC:CBD) with a constant THC concentration and over varying concentrations of THC and CBD (0%-1% w/v THC and CBD) with a constant 1:1 ratio may show the impact of total concentration in addition to the relative THC to CBD ratio on the results.

In summary, image analysis was applied to 35 different Cannabis samples of known THC and CBD concentrations and ratios. Threshold values were then defined based on these known Cannabis samples to demonstrate use of image analysis as an objective method for reporting results as either THC-rich, CBD-rich, similar THC and CBD concentrations, or unexpected (i.e., inconclusive) results.

It is appreciated that, in some embodiments, the computing system disclosed herein, having one or more hardware computer processors configured to execute software instructions, may utilize machine learning to perform the image analysis disclosed herein.

Machine learning (ML) is the use of computer algorithms that can improve automatically through experience and by the use of data. Machine learning algorithms build a model based on sample data, known as training data, to make predictions or decisions without being explicitly programmed to do so. Machine learning algorithms are used where it is unfeasible to develop conventional algorithms to perform the needed tasks.

In certain embodiments, instead of or in addition to performing the functions described herein manually, the system may perform some or all of the functions using machine learning or artificial intelligence. Thus, in certain embodiments, machine learning-enabled software relies on unsupervised and/or supervised learning processes to perform the functions described herein in place of a human user.

Machine learning may include identifying one or more data sources and extracting data from the identified data sources. Instead of or in addition to transforming the data into a rigid, structured format, in which certain metadata or other information associated with the data and/or the data sources may be lost, incorrect transformations may be made, or the like, machine learning-based software may load the data in an unstructured format and automatically determine relationships between the data. Machine learning-based software may identify relationships between data in an unstructured format, assemble the data into a structured format, evaluate the correctness of the identified relationships and assembled data, and/or provide machine learning functions to a user based on the extracted and loaded data, and/or evaluate the predictive performance of the machine learning functions (e.g., “learn” from the data).

In certain embodiments, machine learning-based software assembles data into an organized format using one or more unsupervised learning techniques. Unsupervised learning techniques can identify relationship between data elements in an unstructured format. In certain embodiments, machine learning-based software can use the organized data derived from the unsupervised learning techniques in supervised learning methods to respond to analysis requests and to provide machine learning results, such as a classification, a confidence metric, an inferred function, a regression function, an answer, a prediction, a recognized pattern, a rule, a recommendation, or other results. Supervised machine learning, as used herein, comprises one or more modules, computer executable program code, logic hardware, and/or other entities configured to learn from or train on input data, and to apply the learning or training to provide results or analysis for subsequent data.

Machine learning-based software may include a model generator, a training data module, a model processor, a model memory, and a communication device. Machine learning-based software may be configured to create prediction models based on the training data. In some embodiments, machine learning-based software may generate decision trees. For example, machine learning-based software may generate nodes, splits, and branches in a decision tree. Machine learning-based software may also calculate coefficients and hyper parameters of a decision tree based on the training data set. In other embodiments, machine learning-based software may use Bayesian algorithms or clustering algorithms to generate predicting models. In yet other embodiments, machine learning-based software may use association rule mining, artificial neural networks, and/or deep learning algorithms to develop models. In some embodiments, to improve the efficiency of the model generation, machine learning-based software may utilize hardware optimized for machine learning functions, such as an FPGA.

The system disclosed herein may also be implemented as a client/server type architecture but may also be implemented using other architectures, such as cloud computing, software as a service model (SaaS), a mainframe/terminal model, a stand-alone computer model, a plurality of non-transitory lines of code on a computer readable medium that can be loaded onto a computer system, a plurality of non-transitory lines of code downloadable to a computer, and the like.

The system may be implemented as one or more computing devices that connect to, communicate with and/or exchange data over a link that interact with each other. Each computing device may be a processing unit-based device with sufficient processing power, memory/storage and connectivity/communications capabilities to connect to and interact with the system. For example, each computing device may be an Apple iPhone or iPad product, a Blackberry or Nokia product, a mobile product that executes the Android operating system, a personal computer, a tablet computer, a laptop computer and the like and the system is not limited to operate with any particular computing device. The link may be any wired or wireless communications link that allows the one or more computing devices and the system to communicate with each other. In one example, the link may be a combination of wireless digital data networks that connect to the computing devices and the Internet. The system may be implemented as one or more server computers (all located at one geographic location or in disparate locations) that execute a plurality of lines of non-transitory computer code to implement the functions and operations of the system as described herein. Alternatively, the system may be implemented as a hardware unit in which the functions and operations of the back-end system are programmed into a hardware system. In one implementation, the one or more server computers may use Intel® processors, run the Linux operating system, and execute Java, Ruby, Regular Expression, Flex 4.0, SQL etc.

In some embodiments, each computing device may further comprise a display and a browser application so that the display can display information generated by the system. The browser application may be a plurality of non-transitory lines of computer code executed by a processing unit of the computing device. Each computing device may also have the usual components of a computing device such as one or more processing units, memory, permanent storage, wireless/wired communication circuitry, an operating system, etc.

The system may further comprise a server (that may be software based or hardware based) that allows each computing device to connect to and interact with the system such as sending information and receiving information from the computing devices that is executed by one or more processing units. The system may further comprise software- or hardware-based modules and database(s) for processing and storing content associated with the system, metadata generated by the system for each piece of content, user preferences, and the like.

In one embodiment, the system includes one or more processors, server, clients, data storage devices, and non-transitory computer readable instructions that, when executed by a processor, cause a device to perform one or more functions. It is appreciated that the functions described herein may be performed by a single device or may be distributed across multiple devices.

When a user interacts with the system, the user may use a frontend client application. The client application may include a graphical user interface that allows the user to select one or more digital files. The client application may communicate with a backend cloud component using an application programming interface (API) comprising a set of definitions and protocols for building and integrating application software. As used herein, an API is a connection between computers or between computer programs that is a type of software interface, offering a service to other pieces of software. A document or standard that describes how to build or use such a connection or interface is called an API specification. A computer system that meets this standard is said to implement or expose an API. The term API may refer either to the specification or to the implementation.

Software-as-a-service (SaaS) is a software licensing and delivery model in which software is licensed on a subscription basis and is centrally hosted. SaaS is typically accessed by users using a thin client, e.g., via a web browser. SaaS is considered part of the nomenclature of cloud computing.

Many SaaS solutions are based on a multitenant architecture. With this model, a single version of the application, with a single configuration (hardware, network, operating system), is used for all customers (“tenants”). To support scalability, the application is installed on multiple machines (called horizontal scaling). The term “software multitenancy” refers to a software architecture in which a single instance of software runs on a server and serves multiple tenants. Systems designed in such manner are often called shared (in contrast to dedicated or isolated). A tenant is a group of users who share a common access with specific privileges to the software instance. With a multitenant architecture, a software application is designed to provide every tenant a dedicated share of the instance-including its data, configuration, user management, tenant individual functionality and non-functional properties.

The backend cloud component described herein may also be referred to as a SaaS component. One or more tenants which may communicate with the SaaS component via a communications network, such as the Internet. The SaaS component may be logically divided into one or more layers, each layer providing separate functionality and being capable of communicating with one or more other layers.

Cloud storage may store or manage information using a public or private cloud. Cloud storage is a model of computer data storage in which the digital data is stored in logical pools. The physical storage spans multiple servers (sometimes in multiple locations), and the physical environment is typically owned and managed by a hosting company. Cloud storage providers are responsible for keeping the data available and accessible, and the physical environment protected and running. People and/or organizations buy or lease storage capacity from the providers to store user, organization, or application data. Cloud storage services may be accessed through a co-located cloud computing service, a web service API, or by applications that utilize the API.

The following is a description of an exemplary use case illustrating steps for performing image analysis and chemical detection using a software application implementing the functionality disclosed herein including determining a presence or concentration of a chemical in a sample. In this example, the 4-aminophenol (4-AP) color test is used to screen and classify Cannabis as either cannabidiol (CBD)- or tetrahydrocannabinol (THC)-rich based on the relative THC-to-CBD concentration ratio. Drawbacks of the simplistic and subjective visual approach routinely used with color tests can include variations in the interpretation of a perceived color, whether a consequence of the sample, user, or test chemistry. As an alternative to visual interpretation, objective interpretation can be achieved by implementing an imaging and corresponding image analysis. The software described herein can support the interpretation of the 4-AP color test and may not make recommendations about the testing procedure.

It is appreciated that while this example applies to spot plates rather than test tubes it is not limited to spot plates. After the 4-AP test Reagent B is added, a photo may be taken of the resultant color after 2-3 minutes using an imaging device (i.e., camera or smartphone).

Next, an objective image analysis platform may use predefined threshold values to interpret resultant color changes. The predefined threshold values applied for the 4-AP test may be associated with the following expectant results and color changes:

THC-rich: if the concentration of THC is greater than CBD, then the color test results in a blue color.

CBD-rich: if the concentration of CBD is greater than THC, then the color test results in a pink color.

Similar THC and CBD: similar concentrations can result in mixed blue and pink (e.g., purple).

Blank: no THC or CBD present, or the concentration is below the detection limits.

Inconclusive: any resultant color change not associated with the expected results above (e.g., contaminant or different cannabinoid present).

The operation of the software program may begin by importing an image, image file, or imaging data. In one embodiment, one photo is analyzed at a time.

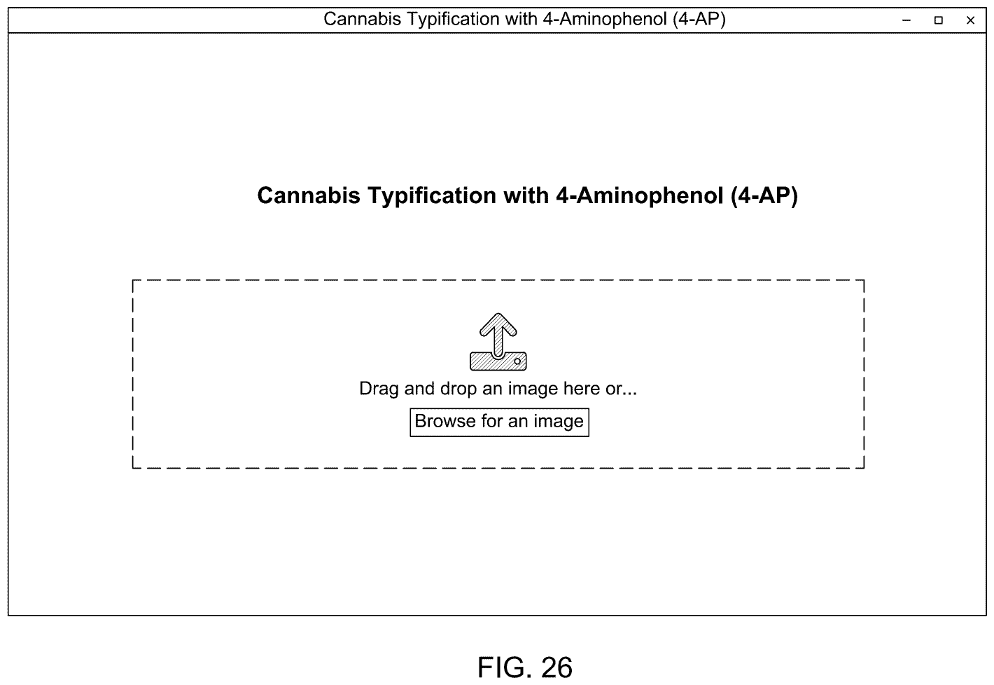

FIG. 26 shows an exemplary user interface for importing imaging data. As shown, the user can drag and drop, or browse and select, one or more image files to be imported. Imported images may be copied to cloud storage or other remote or local storage for processing.

Next, the user may select a white area to color balance the photo. An ideal selection may be an area of white printer paper within the image. A white area may be selected using the cursor. Once an area is selected, a box labeled ‘W’ may appear. This box can then be moved or sized using the cursor and clicking on the circles around the box while dragging to resize. In the example shown, an area of white printer paper within the image is selected.

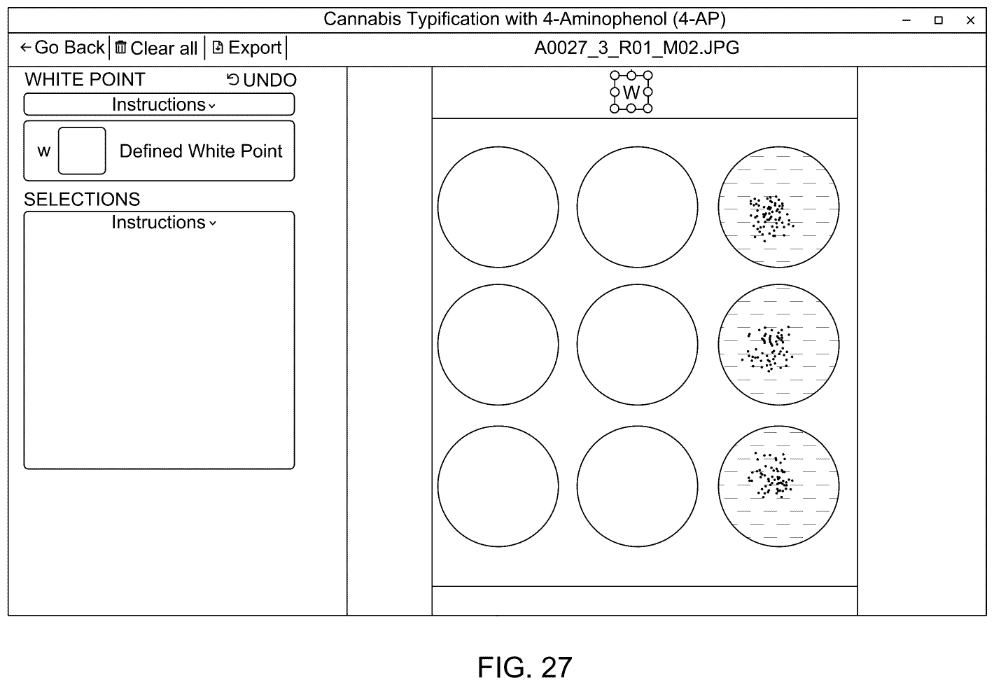

FIG. 27 shows an exemplary user interface for selecting a white area in the image. Here, the user has selected an area that does not contain anything besides a white area and the selected area is surrounded by a box labeled ‘W’.

Next, the user may select one or more well(s) of interest for analysis by clicking on the center of the well(s). The selection may be an area fully encompassed by the resultant colored solution. Once a well is selected, a numbered box may appear. This box can then be moved or sized using the cursor or clicking on the circles around the box while dragging to resize. An example selection that may lead to inadequate results is an area partially containing both the resultant colored solution and the spot plate. The selection sizing feature can be used to size or move the selection box to only contain the resultant colored solution. In the example below, an area fully encompassed by the resultant colored solution is selected for the three used wells. Once a selection is made, notes can be added to each selection as a tag. Tags may be limited to 33 characters and no more than 3 tags per selection in one embodiment. Example tags include case number, evidence number, date, FSSP name, test information, etc.

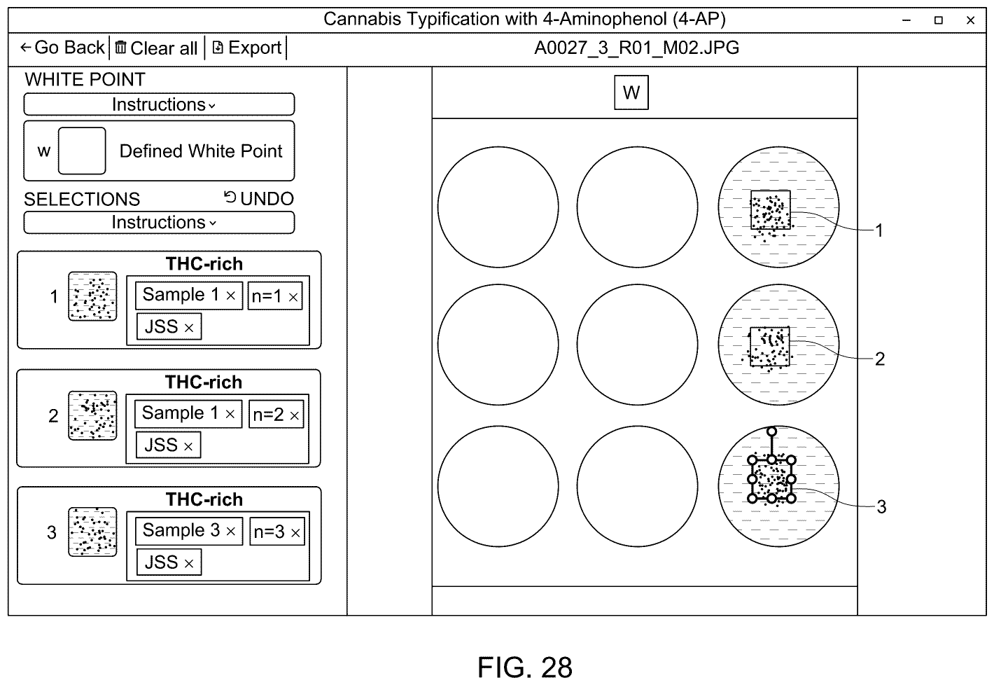

FIG. 28 shows an exemplary user interface for selecting one or more well(s) of interest for analysis. Here, the user has selected three wells of interest, starting from the upper rightmost well (labeled Box 1), continuing down (labeled Box 2), and ending with the bottom rightmost well (labeled Box 3).

Finally, the user can review the classifications within the program or, optionally, classifications can be exported and viewed in an Excel file using the ‘Export’ feature. An exported Excel spreadsheet may include various information such as selection numbering, tags added, selection images, the detected color, and the classification (i.e., THC-rich, CBD-rich, Blank, Inconclusive). Additionally, the date of the export may be automatically populated. Additional areas can be used to fill in additional relevant information, as desired.

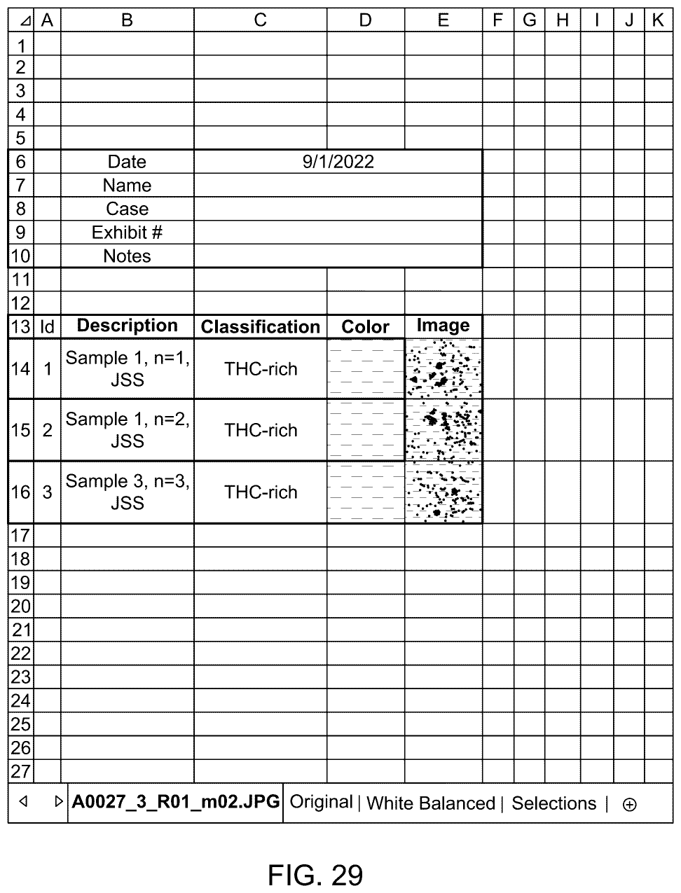

FIG. 29 shows an exemplary Excel spreadsheet exported from the software program for reviewing the classifications. Here, in an upper portion of the spreadsheet the date of export has been populated (Sep. 1, 2022). A lower portion of the spreadsheet includes an ID, description, classification, visual representation of the color used for classification, and an image of the selection. The description for the first sample includes Sample 1, n=1, JSS. The classification indicates that the sample is THC-rich. Visual observation of the visual representation of the color used for classification and the image of the selection can help the user confirm the classification because the user may know, based on experience, that the dark blue color shown is associated with a THC-rich sample.

As will be appreciated by one skilled in the art, aspects of the present invention may be embodied as a system, method or computer program product. Accordingly, aspects of the present invention may take the form of an entirely hardware embodiment, an entirely software embodiment (including firmware,

resident software, micro-code, etc.) or an embodiment combining software and hardware aspects that may all generally be referred to herein as a “circuit,” “module”, “platform” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computing system for image analysis, the computing system comprising:
one or more hardware computer processors configured to execute software instructions; and
one or more storage devices storing software instructions for execution by the one or more hardware computer processors configured to cause the computing system to:
receive imaging data of at least one sample droplet of a sample and at least one reagent;
identify one or more imaging properties from the imaging data;
generate a result indicating the presence or concentration of a chemical in the sample based on the identified imaging properties; and
store the imaging data and the result.

2. The computing system of claim 1, wherein the at least one reagent is associated with at least one of: an immunoassay, a colorimetric reaction assay, and a chemical indicator.

3. The computing system of claim 1, wherein the computing system is configured to identify the imaging properties based on a subset of the imaging data.

4. The computing system of claim 3, wherein the computing system is configured to identify one or more image pixels to be analyzed and one or more image pixels to be excluded from being analyzed.

5. The computing system of claim 1, wherein the computing system is configured to generate a result based on the identified imaging properties by applying at least one criterion associated with the at least one reagent.

6. The computing system of claim 1, wherein the identified imaging properties include at least one of: a size, a location, a color, and an indicator.

7. The computing system of claim 1, wherein the imaging data is convertible into a viewable image.

8. The computing system of claim 1, further comprising an additional device configured to at least one of: transport, aliquot, split, combine, or mix the at least one sample droplet and the at least one reagent.

9. The computing system of claim 8, wherein the additional device is one of: a test tube, a containment tube, a PCR tube, a multiple-well plate, a spot plate, a cuvette, a lateral flow assay, a test strip, pH paper, a substrate material, a reagent 3D printed into a polymeric material, a microfluidic system, and a digital microfluidic system.

10. The computing system of claim 9, wherein the digital microfluidic system comprises:
a microfluidic device comprising:
a substrate;
one or more microfluidic channels arranged on or within the substrate;
one or more electrodes arranged on or within the substrate;
a first portion of the microfluidic device configured to receive the at least one reagent; and
a second portion of the microfluidic device configured to receive the at least one sample droplet; and
a microprocessor coupled to the microfluidic device configured to combine the at least one sample droplet and the at least one reagent by applying one or more electric potentials to the one or more electrodes.

11. A computer-implemented method for image analysis, the method comprising:
receiving imaging data of at least one sample droplet of a sample and at least one reagent;
identifying one or more imaging properties from the imaging data;
generating a result indicating a presence or concentration of a chemical in the sample based on the identified imaging properties; and
storing the imaging data and the result.

12. The method of claim 11, wherein the at least one reagent is associated with at least one of: an immunoassay, a colorimetric reaction assay, and a chemical indicator.

13. The method of claim 11, wherein identifying the one or more imaging properties from the imaging data is based on a subset of the imaging data.

14. The method of claim 13, wherein the identifying the one or more imaging properties from the imaging data includes identifying one or more image pixels to be analyzed and one or more image pixels to be excluded from being analyzed.

15. The method of claim 11, wherein generating the result based on the identified imaging properties includes applying at least one criterion associated with the at least one reagent.

16. The method of claim 11, wherein the identified imaging properties include at least one of: a size, a location, a color, and an indicator.

17. The method of claim 11, further comprising converting the imaging data into a viewable image.

18. The method of claim 11, wherein the at least one sample droplet and the at least one reagent are at least one of: transported, aliquoted, split, combined, or mixed prior to receiving the imaging data.

19. The method of claim 18, wherein the at least one sample droplet and the at least one reagent are contained in one of: a test tube, a containment tube, a PCR tube, a multiple-well plate, a spot plate, a cuvette, a lateral flow assay, a test strip, pH paper, a substrate material, a reagent 3D printed into a polymeric material, a microfluidic system, and a digital microfluidic system.

20. The method of claim 19, further comprising, at the digital microfluidic system, combining the at least one sample droplet and the at least one reagent, wherein the digital microfluidic system includes:
a microfluidic device comprising:
a substrate;
one or more microfluidic channels arranged on or within the substrate;
one or more electrodes arranged on or within the substrate;
a first portion of the microfluidic device configured to receive the at least one reagent; and
a second portion of the microfluidic device configured to receive the at least one sample droplet; and
a microprocessor coupled to the microfluidic device configured to combine the at least one sample droplet and the at least one reagent by applying one or more electric potentials to the one or more electrodes.
